(19) United States
(12) Patent Application Publication
(10) Pub. No.: US 2026/0148563 A1
(43) Pub. Date: May 28, 2026

(54) Trajectory Tracking and Dynamic Region of Interest Identification

(71) Applicant: Metropolis IP Holdings, LLC, Santa Monica, CA (US)

(72) Inventors: Ji Sung Hwang, Albany, CA (US); Anil Kumar Nayak, Los Angeles, CA (US); Long Ngo Hoang Truong, Garden Grove, CA (US); Kushal Bhagwan Kusram, Los Angeles, CA (US); Shuai Yan, Davis, CA (US)

(21) Appl. No.: 19/393,241

(22) Filed: Nov. 18, 2025

Related U.S. Application Data
(60) Provisional application No. 63/725,418, filed on Nov. 26, 2024.

(51) Int. Cl. G06V 20/54; G06V 10/25; G06V 10/26; G06V 10/75; G06V 10/762; G06V 10/82

(52) U.S. Cl. CPC G06V 20/54; G06V 10/25; G06V 10/26; G06V 10/751; G06V 10/762; G06V 10/82; G06V 2201/08

(57) ABSTRACT

A method or system for vehicle identification within a vehicle management system is disclosed. The system receives a first sequence of video frames of a first vehicle captured by a camera in a managed facility and determines a first path traversed by the first vehicle based on its locations within the sequence. Similarly, a second sequence of video frames of a second vehicle is received, and a second path is determined based on the locations of the second vehicle. The first and second paths are clustered to identify a region of interest (ROI) within the camera's field of view. Subsequently, in response to receiving a third sequence of video frames of a third vehicle, vehicle identification is performed on portions of the frames that correspond to the identified ROI.

### CROSS REFERENCE TO RELATED APPLICATION

This application claims the benefit of U.S. Provisional Ser. No. 63/725,418, filed Nov. 26, 2024, the entirety of which is incorporated herein by reference.

### TECHNICAL FIELD

The disclosure generally relates to vehicle identification using computer vision, and more particularly relates to application of computer vision machine learning models to targeted portions of images based on trajectory tracking and dynamic region of interest identification.

### BACKGROUND

Vehicle detection in managed facilities, such as parking lots, airports, stadiums, and commercial complexes, can be used to optimize traffic flow, enhance security, and improve overall operational efficiency. For instance, automated entry systems may be equipped with vehicle detection technology that can identify incoming vehicles, verify access permissions, and open gates automatically, reducing the need for manual checks and intervention. This automated process minimizes wait times and congestion at entry and exit points, improving the overall experience for drivers and facility managers alike.

Automated entry systems may install cameras at various locations within a managed facility, such as entrances, exits, and intersections. These cameras capture video frames of adjacent areas, which are then analyzed by either the camera itself or an edge device coupled to the camera to identify vehicles. Since edge devices or cameras are often deployed in large numbers, equipping each device with high-end hardware would significantly increase costs. As a result, trade-offs are typically made in computational power. For instance, edge devices generally have limited RAM, storage, and less powerful CPUs or GPUs, which restrict their ability to process large volumes of data or execute complex algorithms quickly. In some cases, the time required for an edge device to identify a vehicle can extend to several seconds or even minutes, which may lead to traffic slowdowns during busy periods.

### SUMMARY

The embodiments described herein address the above-described issues by using machine learning models to identify regions of interest within the fields of view of cameras. By enabling edge devices to process only these regions of interest, the computational workload required to identify vehicles is significantly reduced, thereby increasing the speed of vehicle identification. In some embodiments, the system receives images of vehicles captured by one or more cameras in a managed facility as each vehicle enters or exits a zone within the facility. The system analyzes these images to detect the movement paths of multiple vehicles, clusters these detected paths to identify a region of interest, and then directs the cameras to focus on this region of interest for vehicle identification.

For example, when a first vehicle passes by a camera, a sequence of video frames of the vehicle is captured by the camera. The system analyzes each frame in the sequence to determine the location of the first vehicle within the managed facility and establishes a path traversed by the vehicle based on the determined locations across frames. Similarly, when a second vehicle passes by the camera, a new sequence of video frames of the second vehicle is captured. The system again analyzes each frame in this sequence to determine the second vehicle's location in the facility and generates a path based on these locations. The system then clusters the paths of the first and second vehicles to identify a region of interest within the camera's field of view. Upon receiving a third sequence of video frames of a third vehicle, the system performs vehicle detection based only on the portions of these frames that correspond to the identified region of interest.

In a similar manner, the system can identify regions of interest within the fields of view of other cameras, performing vehicle detection based on images captured by these cameras within their respective regions of interest.

In some embodiments, the system also applies a machine learning model to the pixels of captured images to classify each pixel as either part of a lane or not and segments areas in a picture frame as a lane region or a non-lane region. The system then further refines the region of interest based on the identified lane region or non-lane region. In some embodiments, the system generates a mask to block areas outside the region of interest.

By focusing only on portions of images corresponding to regions of interest (e.g., portions that remain after applying the mask), the system conserves computational resources by analyzing only where vehicles are likely to be detected. Notably, image processing applications, including those used for vehicle detection, such as identifying license plates or vehicle characteristics, are computationally intensive. This targeted approach minimizes unnecessary image processing, as it avoids examining every pixel of an image or video frame. With less data to analyze per frame, the system can significantly speed up processing time compared to analyzing the entire frame. Furthermore, because the system focuses only on the relevant areas, it also reduces the likelihood of processing irrelevant data, which could otherwise lead to false positives or misidentifications. Accordingly, the system achieves faster and more accurate vehicle identification.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates an example system environment for managing vehicle parking or transit through a managed facility, using an edge device and a vehicle management server, in accordance with one or more embodiments.

FIG. 2 illustrates an example architecture of an edge device, in accordance with one or more embodiments.

FIG. 3 illustrates an example architecture of a vehicle management server, in accordance with one or more embodiments.

FIG. 4 illustrates an example architecture of an ROI identification module, in accordance with one or more embodiments.

FIG. 5 illustrates an example environment where an ROI identification module may be used to identify regions of interest (ROIs), in accordance with one or more embodiments.

FIG. 6 is a block diagram illustrating components of an example machine able to read instructions from a machine-readable medium and execute them in a processor (or controller) in accordance with one or more embodiments.

FIG. 7 is a flowchart of a method for vehicle identification in a managed facility, in accordance with one or more embodiments.

FIGS. 8A-C depict an exemplary managed facility vicinity and moveable gate in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Vehicle identification systems may be employed for traffic management, ensuring security at various checkpoints, and overseeing entry and exit activities in managed facilities. These systems may use a pretrained machine-learning model to identify vehicles as they pass by. For instance, within a managed facility, a vehicle identification system may be configured to recognize and record an identification of a vehicle upon entry and again at exit. This data may facilitate the determination of the vehicle's parking duration. This data may also be used for any number of purposes such as to track activity, feed into access control mechanisms for a managed facility, and so on.

Such machine-learning models may include (but are not limited to) object detection, such as vehicle detection, license plate detection, vehicle identification, and license plate identification, among others. For example, a vehicle detection model can scan images or video frames to locate and recognize a presence of a vehicle. In response to detecting the vehicle, additional machine-learning models may be applied to the area of the vehicle to extract features, and the identification of the vehicle may also be identified based on the extracted features. For example, a license plate may be a feature of the vehicle. A license plate detection model can then scan the area of the vehicle (which may be annotated with a bounding box) to locate and recognize a presence of a license plate. In response to locating a license plate, a license plate recognition model may be applied to the area of the license plate (which may be annotated with a bounding box) to identify the license plate.

Notably, these machine-learning models, such as those used for identifying license plates or vehicle characteristics, are computationally intensive. Embodiments described herein identify regions of interest and causes the vehicle identification system to focus on the regions of interest in applying these machine-learning models. By confining the application of the machine-learning models to the regions of interest, the system allows the algorithm to run faster since they are applied to a smaller portion of each frame.

Additional details about the embodiments are further described below with respect to FIGS. 1-6.

### Configuration Overview

FIG. 1 illustrates one embodiment of a system environment for managing vehicle parking or transit through a managed facility, using an edge device and a vehicle management server. As depicted in FIG. 1, environment 100 includes edge device 110, camera 112, gate 114, data tunnel 116, sensor 118, network 120, a client device 140, and vehicle management server 130. While only one of each feature of environment is depicted, this is for convenience only, and any number of each feature may be present. Where a singular article is used to address these features (e.g., “camera 112”), scenarios where multiples of those features are referenced are within the scope of what is disclosed (e.g., a reference to “camera 112” may mean that multiple cameras are involved).

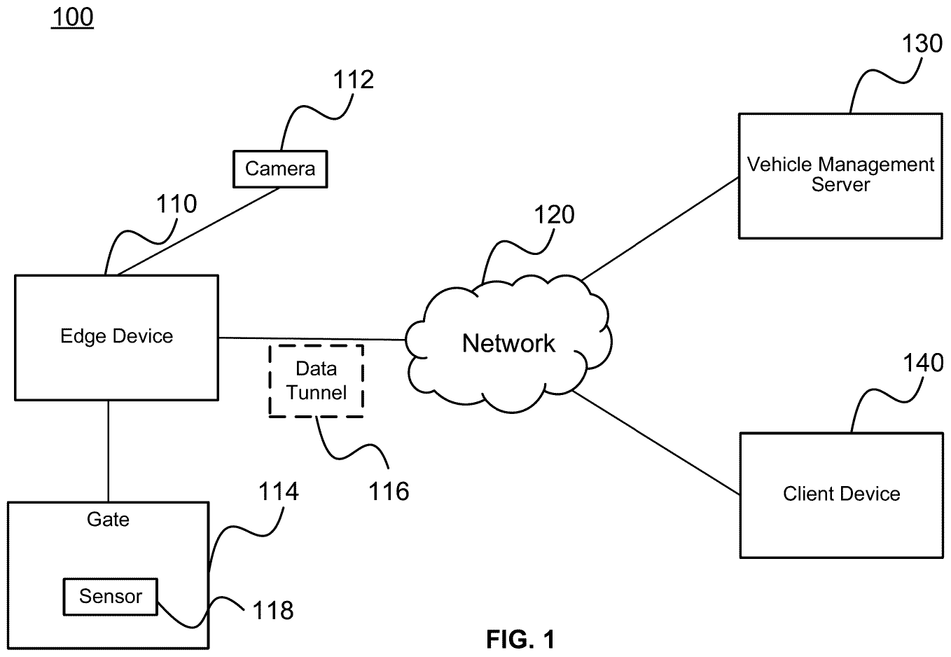

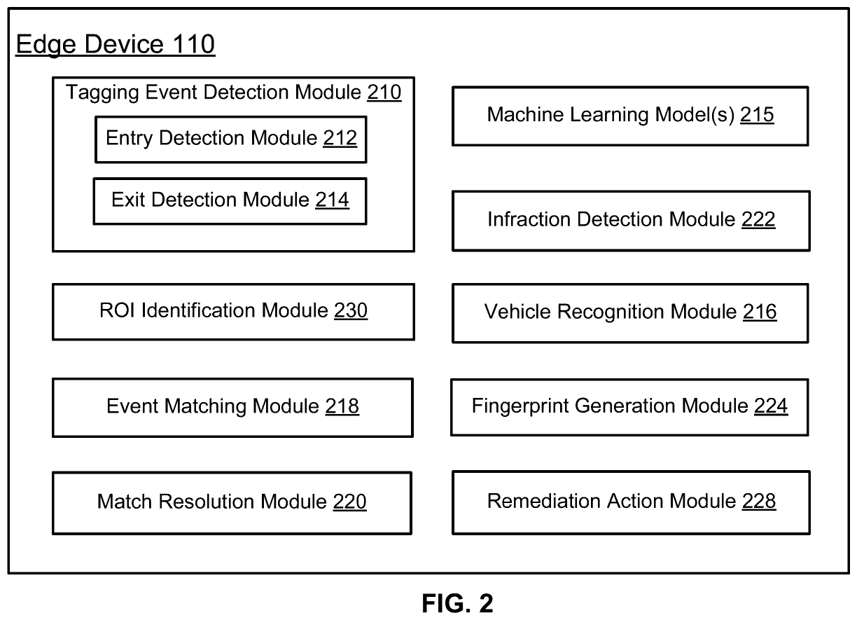

Edge device 110 detects a vehicle approaching gate 114 using camera 112. Edge device 110, upon detecting such a vehicle, performs various operations (e.g., lift the gate; update a profile associated with the vehicle, etc.) that are described in further detail below with reference to at least FIG. 2. Camera 112 may include any number of cameras that capture images and/or video of a vehicle from one or more angles (e.g., from behind a vehicle, from in front of a vehicle, from the sides of a vehicle, etc.). Camera 112 may be in a fixed position or may be movable (e.g., along a track or line) to capture images and/or video from different angles. Where the term image is used, this may be a standalone image or may be a frame of a video. Where the term video is used, this may include a plurality of images (e.g., frames of the video), and the plurality of images may form a sequence that together form the video.

Gate 114 may be any object that blocks entry and/or exit from a facility (e.g., a parking facility) until moved. For example, gate 114 may be a pike that blocks entry or exit by standing parallel to the ground, and lifts perpendicular to the ground to allow a vehicle to pass. As another example, gate 114 may be a pole or a plurality of poles that block vehicle access until lowered to a position that is flush with the ground. Any form of blocking vehicle ingress/egress that is moveable to remove the block is within the context of gate 114. In some embodiments, no physical gate exists that blocks traffic from entering or exiting a facility. Rather, in such embodiments, gate 114 as referred to herein is a logical boundary between the inside and the outside of the facility, and all embodiments disclosed herein that refer to moving the gate equally refer to scenarios where a gate is not moved, but other processing occurs when an entry and exit match (e.g., record that the vehicle has left the facility). Yet further, gate 114 may be any generic gate that is not in direct communication with edge device 110. Edge device 110 may instead be in direct communication with a component that is separate from, but installed in association with, a gate, the component configured by installation to cause the gate to move.

Edge device 110 communicates information associated with a detected vehicle to vehicle management server 130 over network 120, optionally using data tunnel 116. Data tunnel 116 may be any tunneling mechanism, such as virtual private network (VPN). Network 120 may be any mode of communication, including cell tower communication, Internet communication, WiFi, WLAN, and so on. The information provided may include images of the detected vehicle. Additionally or alternatively, the information provided may include information extracted from or otherwise obtained based on the images of the detected vehicle (e.g., as described further below with respect to FIG. 2). Transmitting extracted information rather than the underlying images may result in bandwidth throughput efficiencies that enable real time or near-real-time movement of gate 114 by avoiding a need to transmit high data volume images.

In some embodiments, edge device 110 may apply computer vision to determine environmental factors around the vehicle. The term environmental factors, as used herein, may refer to features that influence traffic flow in the vicinity of gate 114, such as street traffic blocking egress from a facility, orientation of vehicles within images with respect to one another, and so on. In an embodiment, when instructing the moveable gate to move, edge device 110 applies parameters based on the determined environmental factors (e.g., wait to open gate 114 despite matching an exit to an entry due to a vehicle being ahead of the vehicle attempting to exit and therefore blocking egress).

The machine vision may include a license plate detection model. The edge device 110 may apply the license plate detection model to identify license plate numbers on a vehicle when the vehicle enters or exits the managed facility. The identified license plate numbers at the entry event and the exit event may be logged in a database. The entry event and exit event associated with a same license plate number are matched and can be used to determine the vehicle's parking duration in the managed facility or anomalies.

In some embodiments, the edge device 110 may be configured to identify one or more ROIs, and to cause the computer vision to focus on image areas corresponding to the one or more ROIs. In some embodiments, initial ROIs might be set based on a pixel based machine learning model that detects lanes, roadways, and/or parking zones. In some embodiments, the ROIs are dynamically adjusted based on vehicle detections. For example, in response to detecting vehicles in a frame, the edge device 110 can dynamically refine the ROI to update the focus to include areas containing these detected vehicles. For instance, if vehicles are consistently detected in a first area, but not a second area within the frame, the edge device 110 may adjust the ROI to include the first area and exclude the second area. In some embodiments, the ROI is adjusted based on detected trajectories of moving vehicles. Common paths that vehicles traverse may be identified, and edge device 110 may adjust the ROI to cover the common paths or “virtual lanes” that may or may not have lane markings. In places like parking lots, intersections, or temporary parking zones, painted lane markings may be absent, faded, or disrupted. Virtual lanes, based on vehicle movement patterns, provide a way to identify expected paths without relying on physical markers. This is particularly beneficial in environments where adding or maintaining physical lane markings is impractical, or where drivers tend to ignore lanes for reasons of convenience or habit.

In some embodiments, in response to identifying the ROI, a mask is generated and applied to frame of images captured by the camera 112, exposing the ROIs and blocking the areas that are not identified as ROIs. As such, the machine learning models for license plate or vehicle identification are applied within the ROIs. Notably, edge devices 110 generally have limited processing power compared to central servers or cloud systems. By focusing solely on ROIs and masking out irrelevant areas, edge device 110 can substantially reduce the amount of data it needs to process, thereby lowering computational load and enabling faster processing. For instance, if the ROI covers 50% of a full frame, the processing time for vehicle identification can be reduced by 30-50%, depending on the machine learning model and hardware architecture. The operations of edge device 110 are described in further detail below with reference to at least FIG. 2.

Vehicle management server 130 receives the information from edge device 110 and performs operations based on the received information. The operations may include storing the information, updating a profile, retrieving information related to the information, and communicating responsive additional information back to edge device 110. Vehicle management server 130 may control aspects of the managed facility, such as status lights above parking gates.

In some embodiments, the ROI identification is at least partially implemented on the vehicle management server 130. For instance, the vehicle management server 130 may receive images frames from the camera 112, process the received image frames to identify vehicles and track their trajectories, and thereby determine ROIs. In some embodiments, the server 130 may also apply additional pixel-based machine learning models to identify lanes, and overlay the lane detection results with the trajectory tracking results to determine or adjust ROIs. In some embodiments, the server 130 may also generate a mask based on the identified ROIs and deploy the identified ROIs and/or generated masks back to the client device 110 or the camera 112, enabling the ROIs and/or masks to be applied to subsequent images captured by the camera 112.

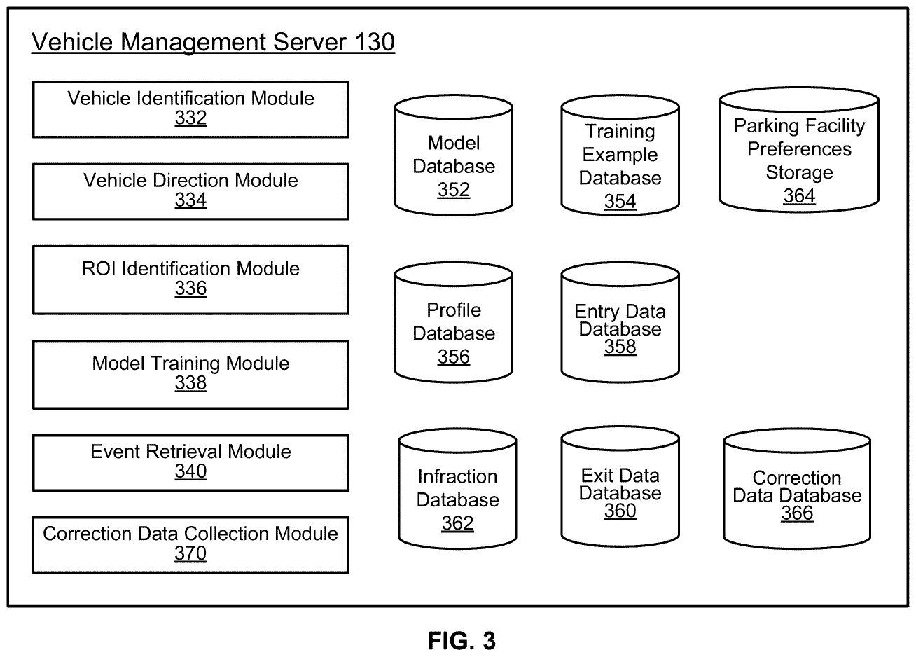

Notably, different cameras are positioned at various locations across managed facilities, each of which may correspond to a different ROI. Accordingly, the vehicle management server 130 may generate a separate mask for each camera based on the images received from that specific camera. The operations of vehicle management server 130 are described in further detail below with reference to at least FIG. 3.

FIG. 2 illustrates one embodiment of exemplary modules operated by an edge device. As depicted in FIG. 2, edge device 110 includes a tagging event detection module 210, machine-learning model(s) 215, vehicle recognition module 216, event matching module 218, match resolution module 220, infraction detection module 222, ROI identification module 230, fingerprint generation module 224, and remediation action module 228. The modules depicted with respect to edge device 110 are merely exemplary; fewer or additional modules may be used to achieve the activity disclosed herein. Moreover, the modules of edge device 110 typically reside in edge device 110, but in various embodiments may instead, in part or in whole, reside in vehicle management server 130 (e.g., where images, rather than data from images, are transmitted to vehicle management server 130 for processing). In some embodiments, the modules and functionality of edge device 110 may in whole or in part be implemented in sensor 118.

The tagging event detection module 210 is configured to detect and tag certain events. The events that are being tagged may include entry events, exit events, parking events, and backup events, among others. Entry events include an event when a vehicle enters the managed facility. Exit events include an event when a vehicle exits the managed facility. Some managed facilities include multiple zones, such as a commercial zone and a residential zone. In such a managed facility, an entry event may also be an event when a vehicle enters a zone of the managed facility; an exit event may also be an event when a vehicle exits a zone of the managed facility.

Events related to vehicles in a managed facility may occur in sequences that are logically related. Pairing these events helps facilitate effective management of managed facilities. For instance, an entry of a vehicle into a commercial zone (which may be a general mall parking) followed by its transition to a residential zone represents a pair of events that are logically related. Similarly, a vehicle entering a stadium and subsequently accessing a VIP parking area also represents a pair of events that are logically related.

Considering that entry and exit events are commonly detected, further details about these events are discussed below. Additionally, there are other events related to vehicles that can also be tagged and matched in a sequence between an entry event and an exit event. While the descriptions primarily relate to entry and exit events, the embodiments described herein are also applicable to these other events.

In some embodiments, the tagging event detection module 210 includes an entry detection module 212 configured to detect entry events and an exit detection module 214 configured to detect exit events. Entry detection module 212 detects and stores an entry event. An entry event represents a vehicle approaching a managed facility from an entry side and entering the managed facility or a zone of the managed facility, in some embodiments through an entry gate. Entry detection module 212 may detect the entry event by using camera 112 to capture a series of images over time. Camera 112 may continuously capture images or may capture images when certain conditions are met (e.g., motion is detected, or any other heuristic such as during certain times of day). In an embodiment, edge device 110 may continuously receive images from camera 112 and may determine whether the images include a vehicle, in which case entry detection module 212 may perform processing on images that include a vehicle and discard other images. In an embodiment, entry detection module 212 may command camera 112 to only transmit images that include vehicles and may perform processing on those images. The captured images are in association with a moveable gate or logical boundary (e.g., gate 114), in that each camera 112 is either facing a gate or an area in a vicinity of a gate (e.g., just the entry side, just the exit side, or both). Each image may have a timestamp and/or a sequence number. Entry detection module 212 may associate all images that include a motion of a given vehicle from a time the vehicle enters the images until the time that the vehicle exits the images (e.g., during the time that the vehicle approaches the gate and then drives through or past the gate). In some embodiments, entry detection module 212 may, for images that include motion of the given vehicle, isolate portions of the images that contain the vehicle and exclude portions of the images that do not contain the vehicle (e.g., background, environment, other vehicles). For example, entry detection module 212 may put a bounding polygon on a portion of an image that contains the largest vehicle in the frame. From images that contain the vehicle, entry detection module 212 may further isolate or put bounding polygons around a portion of the image that contains a vehicle identifier, such as a license plate.

Entry detection module 212 may determine, from images featuring the vehicle, a data set corresponding to the vehicle. The data set may include parameters that describe attributes of the vehicle and a vehicle identifier. Parameters describing attributes of the vehicle may include both identifying attributes and direction attributes of the vehicle. Identifying attributes may include any information that is derivable from the images that describe the vehicle, such as make, model, color, type (e.g., sedan versus sports utility vehicle), height, length, bumper style, number of windows, door handle type, and any other descriptive features of the vehicle. Direction attributes may refer to absolute direction (e.g., cardinal direction) or relative direction (e.g., direction of the vehicle relative to an entry gate and/or relative to an assigned direction of a lane which the entry gate blocks (e.g., where different gates are used for entry and exit lanes, and where a vehicle is approaching a gate from an entrance to a managed facility through an exit lane, the direction would be indicated as opposite to an intended direction of the lane)). Direction attributes may also be determined relative to a camera's imaging access and are thus indicative of whether the vehicle is moving toward or away from the camera.

The machine-learning model(s) 215 are used to process the images associated with the entry event and exit event. In some embodiments, the entry detection module 212 and the exit detection model 214 apply the machine-learning model(s) 215 to the captured images to determine identifications of the vehicles.

In an embodiment, a single machine-learning model is used to produce the entire data set, both the parameters and the vehicle identifier. In another embodiment, a first machine-learning model is used to determine the parameters and a different second machine-learning model is used to determine the vehicle identifier.

In the two-model approach, entry detection module 212 determines the parameters by inputting images featuring the vehicle into a first machine-learning model, and receiving, as output from the first machine-learning model, the parameters describing attributes of the vehicle. In an embodiment, the output of the first machine-learning model may be more granular, and may include a number of objects in an image (e.g., how many vehicles), types of objects in the image (e.g., vehicle type information, or per-vehicle identifying attribute information), result scores (e.g., confidence in each object classification), and bounding boxes (e.g., of sub-segments of the image for downstream processing, such as of a license plate for use by the second machine-learning model).

The first machine-learning model may be trained to output identifying attributes using example data having images of vehicles that are labeled with one or more candidate identifying attributes. For example, various images from cameras facing gates may be manually labeled by users to indicate the above-mentioned attributes, such as, for each of the various images, a make, model, color, type, and so on of a vehicle. The first machine-learning model may be a supervised model that is trained using the example data to predict, for new images, their attributes.

The first machine-learning model may be trained to output direction attributes of the vehicle using example data, and/or to output data from which entry detection module 212 may determine some or all of the direction attributes. The example data may show motion of vehicles relative to one or more gates over a series of sequential frames, and may be annotated with a lane type (e.g., an entry lane versus an exit lane) and/or a gate type (e.g., exit gate versus entry gate), and may be labeled with a direction between two or more frames (e.g., toward an entry gate, away from an entry gate, toward an exit gate, away from an exit gate). Lane type may be derived by environmental factors (e.g., a model may be trained to recognize through enough example data that a direction past a gate that shows blue sky is an exit direction, and toward a halogen light is an entry direction). From this training, the first machine-learning model may output direction directly based on learned motions relative to gate type and/or lane type, or may output lane type and/or gate type as well as indicia of directional movement, from which entry detection module 212 may apply heuristics to determine the direction attributes (e.g., toward entry gate, away from entry gate, toward exit gate, away from exit gate). That is, a direction vector along with a gate type and/or lane type may be output (e.g., environmental factors may be output along with the direction vector, which may include other information such as lighting, sky information, and so on), and the direction vector along with the environmental factors may be used to determine the direction attribute.

It is advantageous to determine direction attributes along with identifying attributes, as vehicles are being tracked as they move. However, determining direction attributes and identifying attributes in one step may result in false positives. With that being said, a separate model could be used for identifying attribute detection and for direction attribute detection, thus resulting in a three-model approach (two models being used for what above is referenced to as a “first machine-learning model”, each of those separate models trained separately using respective training data for each respective task.

Continuing with the two-model approach, entry detection module 212 determines the vehicle identifier by inputting images featuring a depiction of a license plate of the vehicle into a second machine-learning model. That is, rather than using optical character recognition (OCR), the second machine-learning model may be used to decipher a license plate of the vehicle into a vehicle identifier of the vehicle. OCR methods are often inaccurate for license plate detection due to complexity of license plates, where different fonts (e.g., cursive versus script) are used, often against complex picture-filled backgrounds, different colors, and lighting issues. Moreover, various license plate types are difficult to accurately read because they often include slogans that are not generalizable. Even minor accuracies in OCR readings where one character or a geographical identifier determination is off could cause could result in an inability to effectively identify a vehicle.

To this end, the second machine-learning model may be trained to identify and output both a geographical nomenclature and a string of characters of a vehicle identifier (e.g., either directly, or with a confidence score that exceeds a threshold applied by entry detection module 212). As used herein, the term “geographical nomenclature” may refer to a manner of identifying a jurisdiction that issued the license plate. That is, in the United States of America, an individual state would issue a license plate, and the geographical identifier would identify that state. In some jurisdictions, a country-wide license plate is issued, in which case the geographical identifier is an identifier of the country. A geographical identifier may identify more than one jurisdiction (e.g., in the European Union (EU), some license plates identify both the EU and the member nation that issued the license plate; the geographical identifier may identify both of those places or just the member nation). The term “string of characters” may refer to a unique symbol issued by the jurisdiction to uniquely identify the vehicle, such as a “license plate number” (which may include numbers, letters, and symbols). That is, for each given jurisdiction, the string of characters is unique relative to other strings of characters issued by that given jurisdiction. In some embodiments, a license plate number for a vehicle may include a string of characters where the characters are both vertically written (e.g., read from top to bottom) and horizontally written (e.g., read from left to right). The term “license plate identifier” may refer to the combination of the geographical nomenclature and the license plate number.

To train the second machine-learning model, training examples of images of license plates are used, where the training examples are labeled. In an embodiment, the training examples are labeled with both the geographical jurisdiction and with characters that are depicted within the image. The characters may be individually labeled (e.g., by labeling segments of the image that include the segment), the whole image may be labeled with each character that is present, or a combination thereof. For strings of characters including both vertically and horizontally written characters, the string may be labelled in a standardized format, such as with a left to right, top to bottom rule (e.g., a license plate

$$6 \begin{matrix}C \\ D\end{matrix} 7890$$

may be labelled as AB12345, and a license plate

$$\begin{matrix}A \\ B\end{matrix} 12345$$

may be written as 6CD 7890). In some embodiments, training examples may only be labeled by whether they include both vertically and horizontally written characters, and the second machine-learning model predicts for a new image of a license plate whether the license plate number includes both vertically and horizontally written characters. Following this prediction, entry detection module 212 may apply a third machine-learning model to license plates with vertically and horizontally written characters, the third machine-learning model trained specifically to predict the license plate numbers for license plates with both vertically and horizontally written characters.

In an embodiment, the training examples may be labeled only with the geographical jurisdiction, and the second machine-learning model predicts for a new image of a license plate the geographical jurisdiction. Following this prediction, a third machine-learning model from a plurality of candidate machine-learning models may be selected, each of the candidate machine-learning models corresponding to a different geographical jurisdiction and trained to predict characters of the string of characters from training examples specific to its respective geographical jurisdiction, the selected third machine-learning model selected based on the predicted geographical jurisdiction. The third machine-learning model may be applied to the image or segments thereof that contain each character, thus resulting in a prediction from training examples specific to that jurisdiction.

In any case, the training examples may show examples in any number of conditions, from low lighting conditions, dirty license plate conditions where characters are partially or fully occluded, license plate frame conditions where geographical identifiers (e.g., the word “New York”) are partially or fully occluded, license plate covers render characters hard to directly read, and so on. Advantageously, by using machine learning to predict geographical nomenclature and strings of characters, accuracy is improved relative to OCR, as even where partial occlusion occurs or lighting conditions make characters difficult to read, the second machine-learning model is able to accurately predict the content of the license plate.

In a one-model approach, the manners of training the first and second machine-learning model would be applied to a single model, rather than differentiating what is learned between the two models. This would result in an advantage of providing all inputs as one data set to a model, but could also result in a disadvantage of a less specialized model that has noisier output. Moreover, data and time intensive to train one large model to perform all of this functionality. The large model may be slower and have a lower quality of output than using two separate models. The two-model approach additionally allows for a “fail fast” processing to happen-that is, detect a vehicle and perform processing based on that detection, even before other activity (e.g., license plate reading) is completed.

Regardless of what model approach is used, in an embodiment, entry detection module 212 may determine, from direction attributes of the vehicle, whether the direction attributes of the vehicle are consistent with the function of the entry gate, thus confirming that the vehicle performed an entry event. Namely, the entry detection module 212 determines that the vehicle used or is using the entry lane as opposed to the exit lane. In some embodiments, the entry detection module 212 may move the gate to enable entry to the facility that is blocked by the gate (or where the gate is a logical boundary, record that the vehicle has entered the facility without a need to move the gate).

In some embodiments, entry detection module 212 may determine a feature vector corresponding to the entry event, an “entry feature vector.” To produce the entry feature vector, the entry detection module 212 inputs a depiction of the vehicle into a supervised machine-learning model. The depiction of the vehicle may include the images that include the vehicle, for example as captured by camera 112. In some embodiments, the depiction of the vehicle may include only the isolated portions of the images that contain the vehicle. In some embodiments, the depiction of the vehicle may include other data, such as data from the data set. The supervised machine-learning model outputs the entry feature vector. The entry feature vector may include a plurality of embeddings, where each embedding is derived from one or more dimensions of the depiction of the vehicle. The supervised machine-learning model may be trained to output a feature vector. In some embodiments, the supervised machine-learning model may be trained such that feature vectors corresponding to different vehicles have a maximum amount of distance from each other in the feature space. For example, the supervised machine-learning model may be trained such that a feature vector is penalized based on angular margins between the feature vector and other feature vectors, where the smaller the angular margins, the greater the penalties. This training results in a greater distance between feature vectors.

In some embodiments, the supervised machine-learning model may be a multi-task model, such as a multi-task neural network with branches that are each trained to determine different parameters. The structure of the multi-task model has a set of shared layers and a plurality of branching task-specific layers, each branch of the branching task-specific layers corresponding to a task. The tasks are related within the domain, meaning that each of the tasks determines parameters that are determinable based on a highly overlapping information space. For example, in determining the entry feature vector for the vehicle, the different tasks may predict the license plate of the vehicle, the make and model of the vehicle, and so on. As such, when trained, the shared layers produce information that is useful for performing each of tasks and outputting each of these predictions. Embeddings of the one or more of the shared layers may be used to produce a feature vector.

While the model that entry detection module 212 uses to produce the entry feature vector is described as a supervised machine-learning model, a supervised machine-learning model is merely exemplary. Entry detection module 212 may use other types of models to generate entry feature vectors. For example, entry detection module 212 may use a classification model (e.g., a logistic regression, decision tree, random forest, or naive bayes model) to classify the vehicle in the entry event.

As described later with respect to event matching module 218 and match resolution module 220, the process to match an entry event and an exit event (e.g., a representation of a vehicle exiting the managed facility) may not always require the entry detection module 212 to generate a feature vector. Event matching module 218 may match entry and exit events without using feature vectors. For example, if the vehicle is a known vehicle, event matching module 218 may match an entry event to an exit event based on the vehicle's vehicle identifier alone. Or, in another example, event matching module 218 may match entry events to exit events based on the data set of the entry and exit events, for example matching based on type, model, and color of vehicle. However, responsive to event matching module 218 not finding a match between an entry and exit event, match resolution module 220 may attempt to match entry and exit events using feature vectors. Match resolution module 220 may request feature vectors from entry detection module 212. As such, in some embodiments, to avoid generating feature vectors when they may not necessarily be used in the matching process, entry detection module 212 may hold off on generating a feature vector responsive to detecting entry of a vehicle and instead produce an entry feature vector responsive to receiving a request from match resolution module 220. This approach saves on computer resources (e.g., processing power, memory) by first attempting less computationally expensive means to match entry and exit events before producing feature vectors.

Entry detection module 212 may store the entry event corresponding to the vehicle in entry data database 358 of the vehicle management server 130. The entry event corresponding to the vehicle includes the data set corresponding to the vehicle (e.g., the parameters and the vehicle identifier) and, in some embodiments, the entry feature vector, images featuring the vehicle, timestamps corresponding to the entry (e.g., time stamps and/or sequence numbers of the images), and the managed facility the vehicle entered. In an embodiment, the entry detection module 212 may store the entry event at edge device 110.

Exit detection module 214 operates in a manner similar to entry detection module 212, in that machine learning is applied in in a similar manner in order to detect an exit event. That is, a data set and/or feature vector identical to that determined when a vehicle performs an entry motion is performed for an exit motion, where it is detected that a vehicle is approaching gate 114 to exit a facility or a zone of the facility. When an exit motion is detected (e.g., where a vehicle is determined to have directional attributes consistent with approaching a gate designated for use as an exit), exit detection module 214 determines that an exit event may have occurred (e.g., and other activity such as generation and storage (e.g., in exit data database 360) of a data structure or a feature vector as described with respect to entry events may be performed). In some embodiments, exit detection module 214 may determine the feature vector in response to the edge device 110 determining that an exit event does not match an entry event.

Vehicle recognition module 216 determines if a vehicle is a known vehicle. A known vehicle is a vehicle with a profile stored in profile database 356. Vehicle recognition module 216 may retrieve the vehicle identifier (e.g., license plate) from the entry event associated with the vehicle (e.g., stored in entry data database 358). Vehicle recognition module 216 may search the profile database 356 using the vehicle identifier as an index. Responsive to finding an entry in profile database 356 that corresponds to the vehicle identifier, vehicle recognition module 216 determines that the vehicle is known. Vehicle recognition module 216 may determine if a vehicle is a known vehicle responsive to a vehicle entering or exiting the managed facility and as such may update the respective entry data database 358 or exit data database 360 with the vehicle identifier or with an indication that the vehicle is known and has a profile in profile database 356.

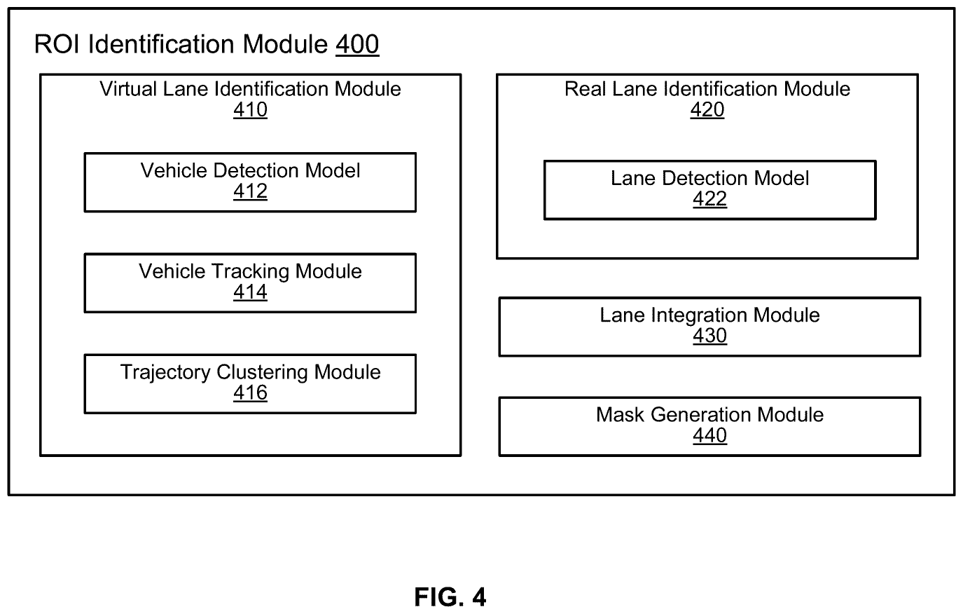

The ROI identification module 230 is configured to identify one or more ROIs in frames of images captured by the camera 112, and cause the different machine learning models 215 to be applied only to the identified ROIs. In some embodiments, the ROI identification module 230 analyzes video frames captured by the camera 112 to identify vehicles, and track vehicles' trajectories. Notably, different vehicles may traverse a slightly different trajectory. The ROI identification module 230 clusters the different trajectories to identify one or more ROIs within a field of view of the camera 112. In response to receiving a new sequence of video frames, the ROI identification module 230 causes the edge device 110 to perform vehicle identification based on portions of the new sequence of video frames that corresponds to the identified ROIs. In some embodiments, the ROI identification module 230 is partially implemented in the vehicle management server 130. Additional details about ROI identification module 230 are further described below with respect to FIG. 4.

Event matching module 218, responsive to exit detection module 214 detecting an exit event, determines whether a match exists between the detected exit event and an entry event. Namely, event matching module 218 determines if a vehicle corresponding to an entry event is the same as the vehicle corresponding to the exit event. In some embodiments, the event matching process may be as simple as determining whether the vehicle corresponding to the exit event is known and matching the exit event to an entry event corresponding to the known vehicle. Event matching module 218 determines whether the vehicle corresponding to the exit event is known by using vehicle recognition module 216, which relies on the vehicle identifier (e.g., license plate) to search profile database 356 for a profile of the vehicle. Responsive to determining that the vehicle corresponding to the exit event is a known vehicle, event matching module 218 may search either entry data database 358 or profile database 356 with the vehicle identifier to determine if there exists a record of the known vehicle entering the managed facility. Responsive to finding an entry event for the known vehicle, event matching module 218 matches the exit event with the entry event.

However, license plate reading, even using the described second machine-learning model, is not perfect. Factors such as low image quality, low frame rate, lighting conditions (e.g., glare, low lighting), debris, dirt, or weather-related conditions (e.g., snow, ice, rain, mud) may obscure license plate information and make license plates difficult to read. As such, vehicle recognition module 216 may be unable to determine whether the vehicle is known based on the vehicle identifier, and as a result the event matching module 218 may not be able to match the exit event to the entry event using the vehicle identifier alone.

In some embodiments, event matching module 218 matches the exit event to an entry event by comparing information in the data set of the exit event to information in the data set of an entry event of a set of entry events. Event matching module 218 determines a match between the exit event and an entry event of the set of entry events where heuristics are satisfied. For example, event matching module 218 may determine that the exit event matches an entry event if the license plate number and geographical nomenclature match. Because license plate numbers are not unique identifiers and can be duplicated so long as the geographical nomenclature is unique, if the exit event and an entry event match between license plate numbers but not between geographical nomenclatures, event matching module 218 would not match the exit event with the entry event. As previously described, because license plate reading is not perfect, it may be the case that a match is not found by event matching module 218 using the vehicle identifier alone. To this end, a match may be determined based on other identifying information from the data sets of the exit and entry events, such as identifying a partial match of a geographical nomenclature and/or other vehicle attributes that match such as make, model, color, and so on. Any heuristics may be programmed to determine whether or not a match has occurred.

Event matching module 218 may filter the entry events to compare the exit event to. For example, event matching module 218 may compare the exit event only to unmatched entry events, to entry events associated with the same managed facility, or to entry events with timestamps within a threshold time window (e.g., within a 24-hour time window). Event matching module 218 may filter entry events such that the set of entry events includes events associated with vehicles of the same type (e.g., car or truck), color, or model as the vehicle associated with the entry event.

Responsive to detecting a match, event matching module 218 may instruct vehicle management server 130 to indicate in profile database 356, entry data database 358, or the exit data database 360 that the vehicle has exited the facility. For example, event matching module 218 may instruct vehicle management server 130 to delete the entry event and exit event of the vehicle or to archive them in a separate database. In some embodiments, responsive to detecting a match, event matching module 218 may raise gate 114 (e.g., where gate 114 is a physical gate rather than a logical boundary), thus allowing the vehicle to exit the facility.

Responsive to not detecting a match, event matching module 218 may expand the set of entry events that the exit event could be matched to and retry the matching process. For example, event matching module 218 may expand the set of entry events to include entry events associated with managed facilities beyond the managed facility associated with the exit event, such as managed facilities within a threshold distance from the managed facility associated with the exit event. In another example, event matching module 218 may expand the time window the entry events are associated with, for example to include entry events that took place within a month instead of within a day.

In some embodiments, responsive to not detecting a match between the exit event and an entry event, event matching module 218 may refer to match resolution module 220.

Match resolution module 220 resolves matches between exit events and hanging entry events. A hanging entry event is an entry event for a vehicle where entry detection module 212 was unable to identify a vehicle identifier. Match resolution module 220 may determine (e.g., by exit detection module 214) or retrieve (e.g., from exit data database 360) an exit feature vector corresponding to the exit event. Match resolution module 220 may determine (e.g., by entry detection module 212) or retrieve (e.g., from entry data database 358) a set of entry feature vectors corresponding to a set of hanging entry events. Match resolution module 220 may input the exit feature vector and the set of entry feature vectors into an unsupervised machine-learning model.

The unsupervised machine-learning model may output a matching score for each entry feature vector. The matching score may represent how well the entry event matches with the exit event such that better matches have higher matching scores. In these embodiments, match resolution module 220 may match the exit event with an entry event based on the matching scores. For example, match resolution module 220 may automatically match the exit event with the entry event that has the highest matching score. In other embodiments, match resolution module 220 may compare the match scores to a threshold score. Responsive to the highest match score exceeding the threshold score, match resolution module 220 may determine the entry event with the highest match score to be a match with the exit event. Responsive to the match scores not exceeding the threshold score, match resolution module 220 may determine that there is no match for the exit event. In some embodiments, match resolution module 220 may compare the difference between the two highest two match scores to a threshold difference and, only in response to the difference exceeding the threshold difference, match the exit event with the entry event with the highest match score. Thus, if the top two entry events are similarly well-matched to the exit event (e.g., with match scores within the threshold difference from one another), match resolution module 220 may determine that there is no match for the exit event. In other embodiments, the match resolution module 220 may provide, for display, a subset of entry events for an administrator to manually select a match for the exit event.

In some embodiments, match resolution module 220 may resolve hanging entry events without waiting for a matching exit event. To do so, match resolution module 220 may match a hanging entry event to a previous entry event, where the previous entry event corresponds to a known vehicle. Match resolution module 220 may determine or retrieve an entry feature vector corresponding to the hanging entry event and determine or retrieve (e.g., from entry data database 358) a set of entry feature vectors corresponding to previous entry events. Match resolution module 220 may input the entry feature vector corresponding to the hanging entry event and the set of entry feature vectors corresponding to previous entry events into an unsupervised machine-learning model. The unsupervised machine-learning model may output a matching score for each entry feature vector that corresponds to a previous entry event.

While the model that match resolution module 220 uses to resolve matches between exit events and hanging entry events is described as an unsupervised machine-learning model, an unsupervised machine-learning model is merely exemplary. Match resolution module 220 may use other types of models to generate entry feature vectors. For example, match resolution module 220 may use a mathematical model that uses cosine similarity to compute the similarity between exit and entry feature vectors.

Match resolution module 220 may select the set of previous entry events. Match resolution module 220 may select entry events that the entry detection module 212 detected within a window of time, such as a window of the last three days. Match resolution module 220 may select entry events that occurred at the same managed facility as the hanging entry event. Match resolution module 220 may select entry events with vehicles of the same type (e.g., truck, SUV, sedan), model, or color as the vehicle corresponding to the hanging entry event. In some embodiments, match resolution module 220 may start by selecting a smaller set of previous entry events where a match may be more likely (e.g., entry events that occurred at the same managed facility in the last 3 days), and, responsive to not resolving a match between the hanging entry event and the selected set of previous entry events, iteratively select larger and larger sets of previous entries with which to retry the matching process (e.g., entry events that occurred within the last month at managed facilities within 20 miles of the managed facility associated with the hanging entry event). Match resolution module 220 may use metrics like retention to further inform selection of the set of previous entry events. For example, if retention (e.g., the rate of vehicles returning to the same managed facility) is 80% in one month, match resolution module 220 may select the set of previous entry events to be entry events that occurred at the same managed facility within one month. However, if retention is 30% in one month, match resolution module 220 may select the set of previous events to be entry events that occurred at a group of managed facilities (e.g., within the same zip code, within a threshold distance) instead of the same managed facility within one month. By using an iterative search process to check sets of previous events where a match is more likely before expanding to check larger sets of previous events, match resolution module 220 may save on time as well as computational resources (e.g., processing power, storage, etc.).

Responsive to the event matching module 218 or match resolution module 220 matching the exit event with an entry event, in some embodiments, edge device 110 may update profile database 356 of the vehicle management server with any or all events, data sets or feature vectors that describe the vehicle. If the vehicle does not have a profile in profile database 356, edge device 110 may request for vehicle management server 130 to create a profile for the vehicle. If the vehicle does have an existing profile in profile database 356, edge device 110 may request for vehicle management server 130 to update the profile with new information corresponding to the vehicle (events, data sets, feature vectors). In some embodiments, edge device 110 may update the entry data database 358 and the exit data database 360 to reflect the match between an exit event and an entry event (e.g., removing entries or indicating that the event is matched).

Responsive to the event matching module 218 or match resolution module 220 not detecting a match, edge device 110 or vehicle management server 130 may provide a message for display to the user of the vehicle corresponding to the exit event. The message may include an indication that the user's vehicle was unable to be matched and/or a request for the user to manually enter vehicle information (e.g., license plate information) or create a profile. The managed facility may display the message on a screen, for example a screen located at the exit gate.

Notably, when the match resolution module 220 matches a hanging entry event and a hanging exit event, a license plate identification associated with at least one of these events is corrected. The corrected data can be gathered to create new training examples, which can then be used to retrain the machine-learning models for vehicle identification. In some embodiments, each recognized license plate is assigned to a confidence score that indicates a probability of its accurate identification. The matched hanging entry event and hanging exit event are each associated with a confidence score. In some embodiments, the license plate identification from the event with the higher confidence score is used for both events in the pair. As such, the event with the lower confidence score is subsequently updated to share the same license plate identification as its matched counterpart, which can then be used to generate a new training example.

Infraction detection module 222 detects infractions caused by vehicles and triggers remediation actions responsive to detecting entry of those vehicles. An infraction may be a violation of rules associated with the managed facility. A set of non-exhaustive examples of infractions may include damaging gates of the managed facility (e.g., bumping into or crashing through entry or exit gates), damaging other vehicles in the managed facility, entering the managed facility with no profile associated with the vehicle, speeding within the managed facility, taking up more than one parking space, parking outside of a parking space, or staying within the managed facility during restricted hours (e.g., overnight, past closing time, for too long a time period). In some embodiments, infraction detection module 222 may detect infractions caused by users of the managed facility, both users associated with vehicles and users not associated with vehicles. Infractions caused by users may, for example, include damaging, breaking into, or stealing vehicles.

Infraction detection module 222 may detect an infraction based on sensor data. Sensor data may include data from camera 112, sensor 118 attached to gate 114, a parking sensor, an audio sensor, a speedometer, or from any other type of sensor in the managed facility. A parking sensor detects when a vehicle is in a parking space. Example parking sensors include magnetometers, ultrasonic sensors, or optical sensors. Infraction detection module 222 may use different sensors for different types of infractions. For example, infraction detection module 222 may use sensor 118 to detect if a gate has moved from one of the operating states (e.g., open, closed) to a state of being ajar, which may indicate that a vehicle bumped into the gate. In another example, infraction detection module 222 may use an audio sensor to detect when a vehicle is broken into (e.g., by detecting the sound of glass shattering or a car alarm).

In some embodiments, infraction detection module 222 may use multiple sensors in combination to detect the infraction. For example, infraction detection module 222 may use camera 112 and a combination of parking sensors to determine if a vehicle is in more than one parking space. Responsive to two or more parking sensors for two or more adjacent parking spaces detecting that the parking spaces have transitioned from a vacant state (e.g., no vehicle detected) to an occupied state (e.g., vehicle detected) within a threshold amount of time, infraction detection module 222 may detect an infraction. Infraction detection module 222 may use camera 112 data to confirm whether the instance of two parking sensors for adjacent parking spots detecting vehicles at the same time included the parking sensors detecting two or more separate vehicles that happened to pull in at the same time or detecting one vehicle taking up multiple parking spaces. In another example, infraction detection module 222 may use an audio sensor to detect the sounds of shattering glass and a car alarm and use camera 112 to confirm an infraction involving a user breaking into a vehicle.

In some embodiments, infraction detection module may use a moveable camera system. A set of non-exhaustive examples of moveable camera systems include a camera on wheels (e.g., on a vehicle), a camera configured to move along a wire or beam running across a ceiling, and/or a drone camera. Infraction detection module 222 may command the moveable camera system to navigate to the location of the infraction. For example, infraction detection module 222 may command the moveable camera system to navigate to a vantage point comprising the aforementioned adjacent parking spaces, capture images of the adjacent parking spaces, and determine whether the vehicle is occupying the adjacent parking spaces. In some embodiments, infraction detection module 222 may command the moveable camera system to navigate to the location of the infraction responsive to sensor data from another sensor (e.g., parking sensor) detecting the infraction. In some embodiments, infraction detection module 222 may command the moveable camera system to periodically move through the managed facility, scanning for infractions. For detecting infractions, a moveable camera system may be more efficient than a system with many stationary cameras as it reduces resources required to install cameras throughout a managed facility and maintain the cameras (e.g., power the cameras while the managed facility is open). Moreover, by triggering navigation of the moveable camera system responsive to detection of certain sensor data, fuel, energy, and processing of images from the moveable camera system is minimized to only scenarios where the possibility of an infraction is first detected, thereby improving efficiency.

In some embodiments, infraction detection module 222 may log the infraction in infraction database 362 along with other information associated with the infraction (e.g., timestamp).

Fingerprint generation module 224 generates a vehicle fingerprint in response to the detection of an infraction. A vehicle fingerprint for an infracting vehicle may include a feature vector corresponding to the vehicle, an “infraction feature vector.” The fingerprint may include other information associated with the vehicle, for example a vehicle identifier or various vehicle parameters. Fingerprint generation module 224 generates the vehicle fingerprint by inputting a depiction of the vehicle into a model (e.g., a supervised machine-learning model). The depiction of the vehicle may include the images that include the vehicle, for example as captured by camera 112. The model may be similar to the supervised machine-learning model or other models described with respect to entry detection module 212 and thus may be trained as discussed with respect to entry detection module 212. Fingerprint generation module 224 receives, as output from the model, an infraction feature vector describing the vehicle involved in the detected infraction. The infraction feature vector may include a plurality of embeddings, where each embedding is derived from one or more dimensions of the depiction of the vehicle. In some embodiments, fingerprint generation module 224 adds the infraction feature vector to an infraction database, such as infraction database 362. In some embodiments, fingerprint generation module 224 generates a vehicle fingerprint without the detection of an infraction.

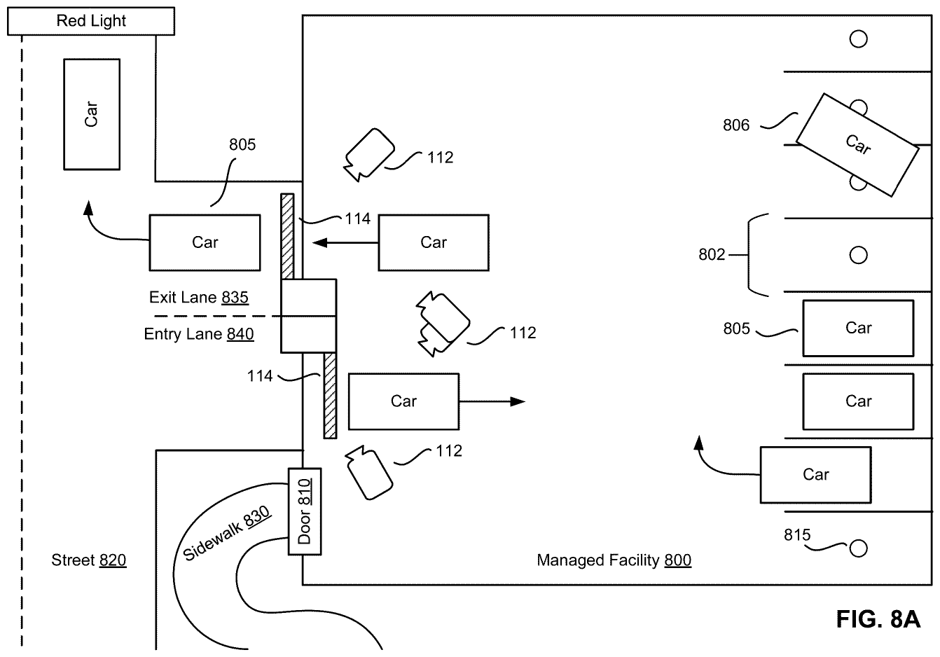

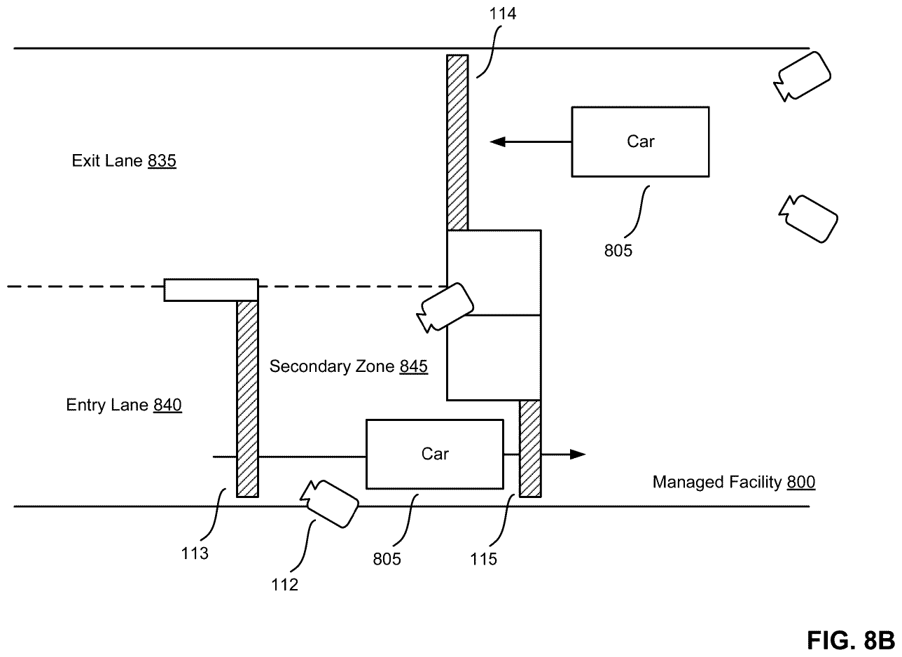

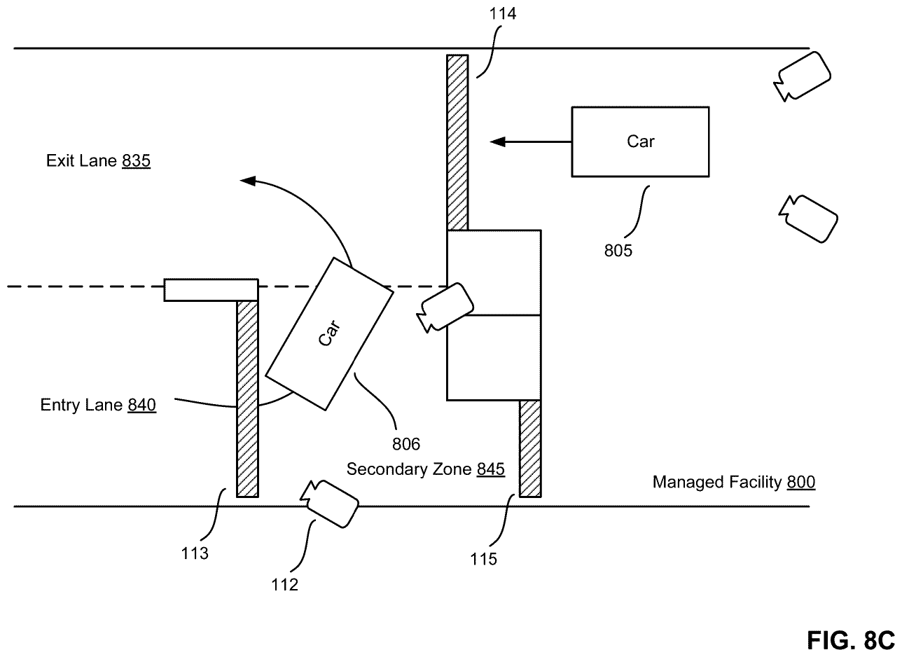

In embodiments where infraction detection module 222 detects an infraction caused by a user, fingerprint generation module 224 may determine a vehicle associated with the user and generate a vehicle fingerprint for the user's vehicle. To do so, fingerprint generation module 224 may retrieve a timestamp of the infraction from infraction database 362. Fingerprint generation module 224 may access sensor data (e.g., RFID reader on a locked pedestrian door to the managed facility, camera 112) within a threshold time window around the timestamp of the infraction. Using the sensors, fingerprint generation module 224 may determine how the user entered the managed facility. Responsive to determining that the user entered through an RFID-enabled pedestrian door to the managed facility, fingerprint generation module 224 may access logs associated with the pedestrian door and access a set of user credentials through which the user gained entry into the managed facility. User credentials may include user information, such as user profile information, through which fingerprint generation module 224 may obtain the vehicle identifier associated with the user. Responsive to determining that the user entered the managed facility in a vehicle, fingerprint generation module 224 may obtain the vehicle information stored in the entry log associated with the vehicle. Such embodiments are further described with respect to FIG. 8A.

In some embodiments, fingerprint generation module 224 determines whether the vehicle is unknown and generates a vehicle fingerprint in response to the vehicle being unknown. The vehicle may be determined by fingerprint generation module 224 to be unknown responsive to determining that the vehicle does not exist in profile database 356 or if the vehicle identifier (e.g., geographical nomenclature and license plate number) for the vehicle is not recognized. To determine if the vehicle is unknown, fingerprint generation module 224 may extract the vehicle identifier from the vehicle using a model similar to the supervised machine-learning model described with respect to entry detection module 212. Fingerprint generation module 224 may search the profile database 356 using the vehicle identifier as an index. Responsive to determining that the vehicle is known, fingerprint generation module 224 may use an existing feature vector of the vehicle (e.g., an entry or exit feature vector stored in profile database 356) as the infraction feature vector of the vehicle fingerprint.

Entry detection module 212 monitors for the entry of vehicles associated with infractions to any of a plurality of managed facilities. At each managed facility, entry detection module 212 may receive, from entry detection module 212, a data set and/or entry feature vector corresponding to a vehicle entering the managed facility. Entry detection module 212 may compare the entry feature vector of the vehicle to vehicle fingerprints stored in the infraction database. In some embodiments, entry detection module 212 may input the entry feature vector and a set of infraction feature vectors (e.g., from vehicle fingerprints) into a model and receive, as output from the model, a match score for each infraction feature vector. The model may be similar to the unsupervised machine-learning model of match resolution module 220. The entry detection module 212, similarly to match resolution module 220, may match the entry feature vector to an infraction feature vector of the set of infraction feature vectors based on the matching scores.

Remediation action module 228 triggers a remediation action responsive to entry detection module 212 detecting the entry of a vehicle associated with an infraction. Example remediation actions include issuing an infraction (e.g., parking ticket or other citation), contacting an administrator of the managed facility, contacting an external authority (e.g., law enforcement), deploying an exit or entry blocking device that prevents movement of the vehicle within the managed facility (e.g., metal bars, tire shredder, closing or not opening the gate), displaying a message to a user associated with the vehicle, or otherwise requesting an action from the user (e.g. email, text, or push notification). An example remediation action is shown with respect to FIG. 8C.

In some embodiments, remediation action module 228 triggers different remediation actions for different types of infractions. As such, remediation action module 228 may determine the type of infraction and transmit a remediation command resulting in the remediation action based on the infraction type. For example, for the infraction of entering the managed facility with no profile associated with the vehicle, the remediation action module 228 may trigger an action prompting a user of the vehicle to enter profile details (e.g., contact information, license plate number). In another example, for the infraction of taking up multiple parking spaces, remediation action module 228 may trigger a remediation action that allocates for the use of the multiple parking spaces. For the infraction of damaging a gate, remediation action module 228 may trigger a remediation action of contacting an administrator of the managed facility. In some embodiments, remediation action module 228 may trigger different remediation actions depending on the managed facility. Remediation action module 228 may store remediation action preferences for different managed facilities, for example in managed facility preferences storage 364 of vehicle management server 130. In some embodiments, remediation action module 228 may trigger multiple remediation actions. For example, remediation action module 228 may trigger two remediation actions at once. Additionally or alternatively, remediation action module 228 may trigger a first a remediation action and wait a threshold window of time before cancelling or triggering a second remediation action. For example, remediation action module may issue a message to a user and wait ten minutes before contacting law enforcement. Responsive to the user resolving the issue within the threshold time window, remediation action module 228 may cancel the second remediation action. Responsive to the user not resolving the issue within the threshold time window, remediation action module 228 may trigger the second remediation action.

Remediation action module 228 may remove the vehicle from the infraction database. Remediation action module 228 may remove the vehicle from the infraction database in response to a request from an administrator of a managed facility or in response to the user of the vehicle performing a remediation response corresponding to the remediation action (e.g., creating a profile, addressing a citation, etc.).

FIG. 3 illustrates one embodiment of exemplary modules operated by a vehicle management server. As depicted in FIG. 3, vehicle management server 130 includes vehicle identification module 332, vehicle direction module 334, ROI identification module 336, model training module 338, event retrieval module 340, model database 352, profile database 356, training example database 354, entry data database 358, exit data database 360, infraction database 362, managed facility preferences storage 364, correction data collection module 370, and correction data database 366. The modules and databases depicted in FIG. 3 are merely exemplary, and fewer or more modules and/or databases may be used to achieve the activity that is disclosed herein. Moreover, the modules and databases, though depicted in vehicle management server 130, may be distributed, in whole or in part, to edge device 110, which may perform, in whole or in part, any activity described with respect to vehicle management server 130. Yet further, the modules and databases may be maintained separate from any entity depicted in FIG. 1 (e.g., license plate training module 338 may be housed entirely offline or in a separate entity from vehicle management server 130).

Vehicle identification module 332 identifies a vehicle using the first machine-learning model described with respect to entry detection module 212. In particular, vehicle identification module 332 accesses the first machine-learning model from model database 352, and applies input images and/or any other data to the machine-learning model, receiving parameters of the vehicle therefrom. Vehicle identification module 332 acts in the scenario where images are transmitted to vehicle management server 130 for processing, rather than being processed by edge device 110. Similarly, vehicle direction module 334 determines a direction of a vehicle within images captured at edge device 110 by cameras 112 in the manner described above with respect to entry detection module 212, except by using images and/or other data received at vehicle management server 130 as input, rather than being processed by edge device 110.

Model training module 338 trains the first machine-learning model to predict parameters of vehicles in the manner described above with respect to entry detection module 212. Parameter determination model training module may additionally train the first machine-learning model to predict direction of a vehicle. Parameter determination model training module may access training examples from training example database 354 and may store the models at model database 352. Similarly, model training module 338 may train the second machine-learning model using training examples stored at training example database 354 and may store the trained model at model database 352.

Event retrieval module 340 receives instructions from event matching module 218 to retrieve entry data from entry data database 358 that matches detected exit data, and returns at least partially matching data and/or a decision as to whether a match is found to event matching module 218. Event retrieval module 340 optionally stores the exit data to exit data database 360.

Profile database 356 stores profile data for vehicles that are encountered. For example, identifying information and/or license plate information may be used to index profile database 356. As a vehicle enters and exits facilities, profile database 356 may be populated with profiles for each vehicle that store those entry and exit events. Profiles may indicate owners and/or drivers of vehicles and may indicate contact information for those users. Event retrieval module 340 may retrieve contact information when an event is detected and may initiate communications with the user (e.g., welcome to managed facility message, or other information relating to usage of the facility).

The correction data collection module 370 is configured to collect correction data from the match resolution module 220 and the client device 140. As discussed above, some of the hanging events are automatically resolved by the match resolution module 220, and the remaining hanging events are manually resolved by users via the client device 140. When the hanging events are resolved, a hanging entry event and a hanging exit event are matched, and the identifier of the vehicle in one of the events must be corrected to be the same as the other event to form a match. This corrected identifier associated with the images captured during that event can be transformed into a new training example. The correction data collection module 370 collects and stores the correction data in the correction data database 366 and generates new training examples based on the correction data. These new training examples can then be stored with the training example database 354 and used to retrain the vehicle identification model. The retrained vehicle identification model can then be stored in the model database 352 and deployed onto the edge device 110 to detect identifiers of the license plate from incoming traffic.

In some embodiments, the vehicle management server 130 may include an ROI identification module 336, which operates in conjunction with the ROI identification module 230 in the edge device 110. In some embodiments, computational workload for ROI identification is distributed between the edge device 110 and the vehicle management server 130. Since the vehicle management server 130 is capable of handling computationally intensive tasks, such tasks can be delegated to its ROI identification module 336.

In some embodiments, the vehicle management server 130 receives video frames captured by the camera 112 from the edge device 110. The vehicle management server 130 applies machine learning models trained to detect vehicles in each frame and labels the detected vehicles in the image frame with bounding boxes. Alternatively, the edge device 110 may incorporate the machine learning models to detect vehicles in each video frame, with the labeled video frames then being sent to the vehicle management server 130. Using these labeled video frames, the vehicle management server 130 can track vehicle trajectories within the managed facility. These trajectories are then clustered to define a virtual lane.

In some embodiments, the vehicle management server 130 identifies a center point of the vehicle, and tracks the center point of the vehicle in consecutive image frames. For example, after detecting the vehicle and creating a bounding box around it, the vehicle management server 130 can compute a center point of the bounding box. The center point represents an approximate position of the vehicle in the frame. In some embodiments, the vehicle management server 130 determines the center point's coordinates by averaging a top-left and bottom right corners of the bounding box. In some embodiments, the vehicle management server 130 also determines a width of the vehicle, and the determination of the ROI is based on the trajectory formed by tracking the center point of the vehicle and the width of the vehicle. For example, as the vehicle moves through the managed facility, the vehicle management server 130 determines a trajectory based on the center point of the vehicle across consecutive frames. The vehicle management server 130 also determines the width of the vehicle and adds the width to the center point trajectory to create a buffered path that reflects the entire space area the vehicle is likely to traverse. The vehicle management server 130 can then determine the ROI to encompass the full vehicle footprint.

In some embodiments, the vehicle management server 130 also processes images, whether labeled or unlabeled with bounding boxes corresponding to vehicles, to identify real lanes by analyzing static pixels within the images. The server can then integrate the identified virtual and real lanes into a unified lane, determining an ROI based on this unified lane. In some embodiments, virtual lane detection is conducted to identify the trajectories of vehicle center points. Real lane detection is performed to identify lane boundaries based on detected surface edges. The vehicle management server 130 then determines ROIs by combining the results of the virtual lane detection and real lane detection.

Notably, each camera has a unique pose (corresponding to a position and an orientation of the camera). In some embodiments, the vehicle management server 130 establishes a specific ROI for each camera and deploys this ROI to that camera or its corresponding edge device 110. This causes the edge device 110 to focus on the identified ROI in the captured images for vehicle detection.

FIG. 4 illustrates an example architecture of an ROI identification module 400 (which may correspond to the ROI identification module 230 in FIG. 2 and/or ROI identification module 336 in FIG. 3), in accordance with one or more embodiments. As described above with respect to FIGS. 1-3, the ROI identification module 400 may be implemented at the edge device 110, the vehicle management server 130, or a combination thereof.

The ROI identification module 400 includes a virtual lane identification module 410, a real lane identification module 420, an ROI integration module 430, and a mask generation module 440. The virtual lane identification module 410 is configured to identify a virtual lane based on tracking vehicles'trajectories. A virtual lane is a dynamically generated path that represents the common movement patterns of vehicles in an area where physical lane markings may be absent, unclear, or insufficient. Unlike real lanes, which are typically marked by painted lines or edges of a roadway, a virtual lane is determined by analyzing the trajectories of vehicles and identifying consistent paths they follow over time. For example, at intersections, drivers may take shortcuts that do not precisely follow the marked lanes. Similarly, in areas with wide lanes or unclear lane divisions, such as parking lots or open space, drivers may feel less compelled to adhere to a specific path.

The real lane identification module 420 is configured to identify a real lane based on applying lane detection machine learning models to images of the environment when vehicles may or may not be present. The lane integration module 430 is configured to integrate the virtual lane identified by the virtual lane identification module 410 and the real lane identified by the real lane identification module 420 to generate an integrated lane, which then forms an ROI. The mask generation module 440 is configured to generate a mask based on the integrated ROI.

In some embodiments, the virtual lane identification module 410 includes a vehicle detection model 412, a vehicle tracking module 414, and a trajectory clustering module 416. In some embodiments, the vehicle detection model 412 may include a machine learning model trained to identify and locate vehicles within images or video frames. The machine learning model is trained to analyze features in each frame (such as edges, shapes, and patterns) and recognize vehicles based on the analyzed features.

In some embodiments, the vehicle detection model 412 is trained by accessing a training dataset including images labeled with one or more vehicles (which are deemed as ground truth). The vehicle detection model 412 is applied to the images within the training dataset to predict locations of vehicles, and backpropagation is performed to adjust parameters of the vehicle detection model 412 to reduce differences between the predicted locations of vehicles and labeled locations of vehicles. In some embodiments, analyzing each video frame in the first or second sequence includes generating a bounding box marking a location of the first or second vehicle in the corresponding video frame.

Various machine learning methods may be used to train the vehicle detection model. Such methods may include (but are not limited to) YOLO (you only look once), SSD (single shot multibox detector), faster R-CNN (region-based convolutional neural networks), mask R-CNN, 3D CNNs, DETR (detection transformer), DRL (deep reinforcement learning), and deep SORT (simple online and real time tracking).

YOLO divides an image into grid and predicts bounding boxes and class probabilities for each grid cell. SSD is a deep learning model that performs object detection and classification in a single pass through the neural network. R-CNN generates region proposals, which are then classified as vehicles or non-vehicles. 3D CNNs may be used for spatiotemporal analysis, extracting features over multiple frames to improve vehicle detection in video. DRL can be applied to continuously learn from the environment. Deep SORT is a hybrid model that can combine with detection models like YOLO or SSD to both detect and track vehicles across frames.

DETR is a deep learning model that uses a CNN backbone and a transformer architecture with an encoder-decoder structure to process image features. The encoder takes the sequence of feature vector from the CNN and applies self-attention layers to learn relationships between different parts of the image. The decoder receives a set of fixed-size learnable embeddings for detecting objects. The decode uses cross-attention to focus on relevant parts of the encoded feature map for each query, predicting the objects present in the image.

The methods may also include (but are not limited to) background subtraction, optical flow methods, support vector machines (SVMs). Background substation method detects vehicles by separating foreground objects (e.g., vehicles) from the static background. Optical flow method tracks movement across consecutive frames to detect vehicles by analyzing patterns of motion. In an SVM-based model, HOG (histogram of oriented gradients) features may be extracted from an image. an SVM classifier may be trained to detect vehicles based on these HOG features.

In some embodiments, when a vehicle is detected, the vehicle detection model 412 places a bounding box around the detected vehicle in the image or video frame. The bounding box serves as a spatial marker that identifies the vehicle's location. The bounding box may correspond to coordinates such as center X, Y or the top-left (X, Y) position of the box, width and height of the bounding box. For example, if a vehicle is identified, a bounding box (x_center=320, y_center=240, width=100, height=50) is generated to specify a region in the image where the vehicle is located, allowing for further analysis or tracking. In some embodiments, the model also assigns a class label to each detected vehicle, such as car, truck, motorcycle. The bounding box is associated with a class label, indicating the type of the detected vehicle. In some embodiments, each detection is also associated with a confidence score, which indicates the model's certainty that the detected vehicle is indeed of the predicted class. For example, a confidence score of 0.9 for a car label indicates the model is 90% confident that the detected object is a car. In some embodiments, a threshold is set, and the system filters out low-confidence detections to reduce false positives.

The vehicle tracking module 414 is configured to track a detected vehicle in consecutive image frames to identify a trajectory of the detected vehicle. For example, in response to detecting and marking a vehicle in a first frame, the vehicle tracking module 414 identifies and follows that same vehicle in subsequent frames. The module 414 may use the bounding box in the first frame provided by the detection module 412, and follow the bounding box in the subsequent frames to trace the trajectory of the vehicle. In some embodiments, the vehicle detection model 412 and/or vehicle tracking module 414 may use object re-identification techniques to recognize the same vehicle even if it slightly changes position, orientation, or scale in subsequent frames. Re-identification may be based on features unique to the vehicle, such as size, shape, or color, helping distinguish between vehicles of similar appearance, especially in multi-vehicle scenes.

In some embodiments, the vehicle tracking module 414 utilizes algorithms like Kalman filters or particle filters to predict the vehicle's next position based on its previous movement, improving tracking continuity. These embodiments are advantageous for handling temporary occlusions or interruptions (e.g., if a vehicle is momentarily blocked by another object). In some embodiments, in environments with multiple vehicles, the vehicle tracking module 414 may implement multi-object tracking methods (e.g., simple online and real-time tracking and deep sort) to track multiple vehicles simultaneously.

As the vehicle tracking module 414 tracks the vehicle's position frame by frame, the module 414 generates a trajectory by connecting each of the vehicle's locations over time. This trajectory is a series of points that represents the vehicle's movement path. In some embodiments, a center of the vehicle (e.g., a center of the bounding box) is identified in each frame, and the trajectory is formed by the sequence of center points of the vehicle identified in consecutive frames. Alternatively, a top-left point of the vehicle (e.g., a top-left point of the bounding box) is identified in each frame, and the trajectory is formed by the sequence of top-left points of the vehicle identified in the consecutive frames.

The trajectory can be visualized as a line connecting each detected position or center point of the vehicle, showing the direction, speed, and pattern of movement. In some embodiments, the width and/or height of a vehicle is used to generate a buffered path by adding buffer areas along the center point trajectory based on the vehicle's width and height.

Notably, different vehicles may take slightly different trajectories. For example, some drivers may position their vehicles closer to the right edge of a lane, while others may favor the left edge. Similarly, at an intersection where vehicles are making left turns, one driver might take a sharper turn near the intersection corner, while another might take a wider turn, veering farther into the opposing lane before aligning with the intended path. These variations can arise from differences in vehicle size, speed, driving habits, or the positioning of other vehicles at the intersection. As more trajectories are accumulated, the trajectory clustering module 416 can cluster these trajectories to identify a common path or a “virtual lane”.

In some embodiments, the real lane identification module 420 includes a lane detection model 422 configured to analyze images of an environment to identify physical lane boundaries (also referred to as “real lanes”). In some embodiments, these images are taken from a clear, vehicle-free view. Alternatively, these images are taken when vehicles are passing through. In some embodiments, the lane detection model 422 is trained to recognize lane markings or lane-like features in the environment.

Various machine learning methods may be implemented to train the lane detection model 422. Such methods include (but are not limited to) canny edge detection, Hough transform, color thresholding, histogram peaks, sliding window methods, CNNs, U-Net, LaneNet, spatial CNN (SCNN), recurrent neural networkS (RNNs), LSTMs for temporal analysis, vision transformers (ViT), DPT (dense prediction transformer), RANSAC (random sample consensus), and polynomial fitting.

The outputs of the model 422 may vary depending on the methods implemented. In some embodiments, for each pixel in the image, the model determines whether it belongs to a lane or not, outputting a binary mask (e.g., 1 for lane pixels, 0 for non-lane pixels). This mask highlights all lane areas in the image. In some embodiments, the model 422 can output a series of coordinate (e.g., (x, y) points) along the detected lane lines, representing the lane path in the image. In some embodiments, the model 422 outputs bounding boxes around lane markers. In some embodiments, the model 422 estimates a width of each detected lane based on detected lane edges, and the model 422 may output the detected lane area as a filled polygon or region. In some embodiments, each detected lane or lane segment is assigned a confidence score, indicating the output certainty that the detected line or area represents a lane. In some embodiments, the system filters out low-confidence lane detections, minimizing false positives.

The lane integration module 430 is configured to combine the virtual lane identified by the virtual lane identification module 410 and the real lane identified by the real lane identification module 420 into a unified lane. As described above, the virtual lane represents common vehicle paths based on the actual movement patterns of vehicles in the area, while the real lane represents physical lane boundaries detected in the environment, such as marked lanes on designated driving paths in structured areas. The lane integration module 430 integrates the virtual lane and the real lane to create a unified lane that accounts for both actual lane markings and observed driving patterns.

In some embodiments, the lane integration module 430 determines the unified lane as the intersection of the virtual lane and the real lane, such that only areas included in both the virtual lane and the real lane are deemed part of the unified lane. Alternatively, the lane integration module 430 may determine the unified lane as the union of the virtual lane and the real lane, such that areas included in either the virtual lane or the real lane are deemed part of the unified lane. In response to determining the unified lane, the lane integration module 430 can identify one or more regions of interest (ROIs) based on the unified lane, considering the widths and heights of vehicles. The ROIs represent areas within image frames where vehicles are likely to be detected.

In some embodiments, the virtual lane identification module 410 is configured to identify one or more first ROIs based on the identified virtual lanes, while the real lane identification module 420 is configured to identify one or more second ROIs based on the identified real lanes. The lane integration module 430 is configured to integrate the first ROIs and second ROIs into unified ROIs. In some embodiments, the lane integration module 430 determines the unified ROIs as the intersection of the first ROIs and second ROIs, such that only areas included in both the first ROIs and second ROIs are considered part of the unified ROIs. Alternatively, the lane integration module 430 may determine the unified ROIs as the union of the first ROIs and second ROIs, such that areas included in either the first ROIs or second ROIs are deemed part of the unified ROIs.

The mask generation module 440 is configured to generate a mask based on the identified ROI. The mask causes pixels outside the ROIs to be blocked such that the vehicle identification system only needs to process the pixels within the ROIs.

Notably, different cameras have varying poses. Accordingly, in some embodiments, the ROI identification module 400 may be configured to generate a separate set of ROIs for each camera, enabling the edge device connected to each camera to process only the portions of images that correspond to the specific set of ROIs for that camera.

Further, lanes and driver behavior can change due to various reasons, such as construction, roadwork, temporary events, wear and tear of markings. Additionally, in areas like parking lots or large intersections without clear lane demarcations, drivers may improvise paths rather than strictly adhering to assume lanes. In some embodiments, the system continuously and/or periodically updates the ROIs—for example, on a daily, weekly, or monthly basis. This ensures that the ROIs are dynamically adjusted based on vehicle paths and environmental conditions, enabling the system to adapt to real-time or near-real-time traffic patterns and changes in the environment, such as construction or road blocks.

Notably, in certain situations, such as during construction or roadblocks, real lane data may fail to accurately represent current traffic flow. In some embodiments, the system addresses this issue by avoiding the merging of real and virtual lane data and relying solely on virtual lanes. For example, if the system determines that the discrepancy between the real lane and the virtual lane exceeds a threshold, it relies exclusively on virtual lanes. This approach ensures that ROIs are dynamically adjusted based on actual vehicle trajectories and prevailing environmental conditions.

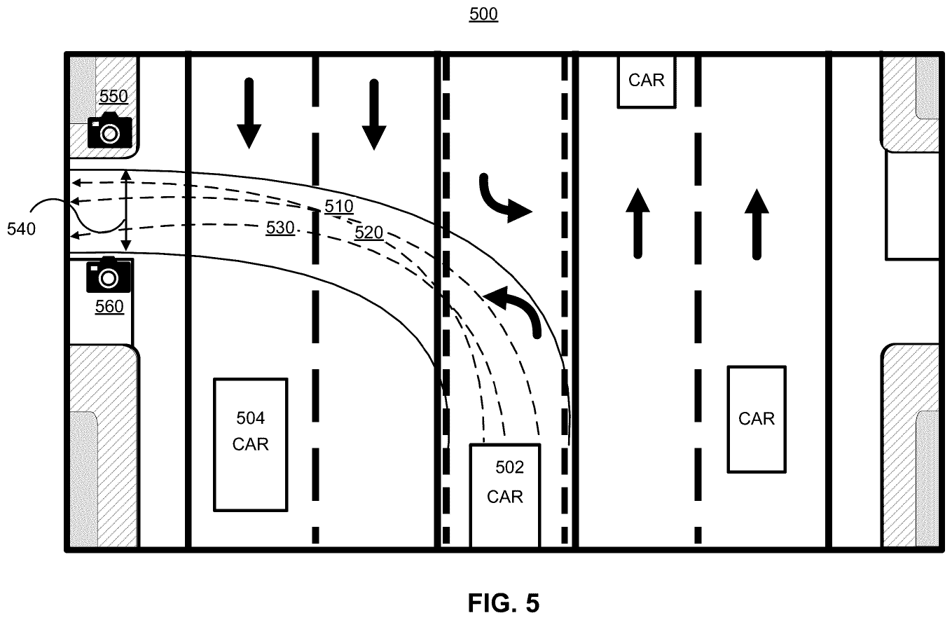

FIG. 5 illustrates an example environment 500 where an ROI identification module 400 may be used to identify regions of interest (ROIs) in accordance with one or more embodiments. The environment 500 includes real lanes, marked with solid and dashed white or yellow lines, defining the boundaries of each physical lane. The real lane identification module 420 can detect these real lanes by utilizing a machine-learning model as described above.

However, as illustrated in FIG. 5, vehicles may not always adhere to lane markings. Additionally, in certain environments (e.g., parking lots or parking garages), lane markings may be absent, faded, or unclear. In such cases, it is not feasible to solely rely on static images of the environment to determine the locations of lanes.

For example, as illustrated, cameras 550 and 560 are positioned at a traffic intersection configured to detect vehicles. Vehicles 502 and 504 are detected, and bounding boxes are generated to indicate the detected vehicles 502 and 504. The system can then track the vehicle 502, 504's trajectories based on their locations on consecutive image frames capture by cameras 550, 560.

Notably, vehicles may turn left at the intersection. The exact path a vehicle takes to make a left turn is not clearly defined by the lane markings. The virtual lane identification module 410 can identify these left-turn paths by tracking the trajectories of vehicles. For example, when making a left turn, a first vehicle takes path 510, a second vehicle takes path 520, and a third vehicle takes path 530. The virtual lane identification module 410 clusters different paths 510, 520, 530 taken by different vehicles into a virtual lane 540. In some embodiments, paths 510, 520, and 530 may be generated by tracking the center point of each vehicle. Additionally, the width and/or height of each vehicle may be determined and used to create a buffered path corresponding to each of the center point-based paths 510, 520, and 530. Alternatively, in some embodiments, a maximum vehicle width (e.g., 7 feet) or a typical vehicle width (e.g., 6.5 feet) may be applied to the center point-based paths to generate a buffered path. The lane integration module 430 can then integrate the real lanes and virtual lanes into unified lanes, which can then be used to determine ROIs.

Further, as discussed above, different cameras are positioned at various locations and angles. For example, a first camera 550 is located on one side of the intersection, while a second camera 560 is positioned on the opposite side. Vehicles may travel through areas identified as unified lanes, which include both virtual and real lanes. As vehicles move through these lanes, they are captured by both cameras 550 and 560. Within each camera's field of view, only a specific subarea corresponds to the lanes traversed by the vehicles. This subarea corresponds to the ROI for each respective camera. The edge device or system is configured to process only the portions of images within each camera's ROI, disregarding regions outside the ROI, to identify vehicles more quickly and efficiently.

In some embodiments, the system may incorporate a mixed 2D and 3D approach for region of interest (ROI) identification, leveraging advanced object detection and tracking techniques. For example, a 3D identification process can replace traditional 2D bounding box generation by using machine learning models capable of producing 3D bounding boxes from 2D camera images. This approach enables the system to integrate spatial depth and object orientation information directly into the detection pipeline without relying on LiDAR or additional hardware.

After 3D bounding box generation, subsequent computations can occur within the 2D space for computational efficiency. For instance, lane segmentation and clustering operations can be performed in the 2D domain, while the 3D orientation and boundaries of detected objects (e.g., vehicles) can provide enhanced fidelity for defining ROIs. The enhanced ROIs offer greater precision by utilizing the boundaries of 3D bounding boxes projected into 2D image space, compared to the simpler geometry of 2D boxes alone. This hybrid approach balances the benefits of 3D spatial awareness with the computational simplicity of 2D processing.

Alternatively, another 3D approach can be employed, where the system reconstructs a 3D scene from 2D camera inputs using a 3D reconstruction model. This model processes image sequences to generate a 3D representation of the environment, allowing all or at least some downstream modules, including object detection, tracking, and lane identification, to operate fully within the 3D space. The final ROIs can then be projected back into the 2D image space for efficient application by edge devices or other systems. This ensures that while the primary computation takes advantage of 3D spatial information, the results remain compatible with existing 2D-focused workflows.

The described 3D approaches provide significant improvements in ROI determination by incorporating depth, orientation, and spatial relationships into the detection and tracking processes. Whether used in a mixed or pure 3D implementation, these methods enhance the accuracy and reliability of detecting and tracking objects within complex environments, while maintaining efficiency suitable for edge devices and large-scale deployments.

The embodiments described above apply machine learning models to identify ROIs, allowing edge devices to concentrate on specific subareas of each camera's field of view where vehicles are most likely to be detected. This targeted processing significantly reduces the computational burden, enabling faster and more efficient vehicle identification. Such advancements represent a technological improvement in image processing and the operation of machine learning models on edge devices.

### Example Computer System

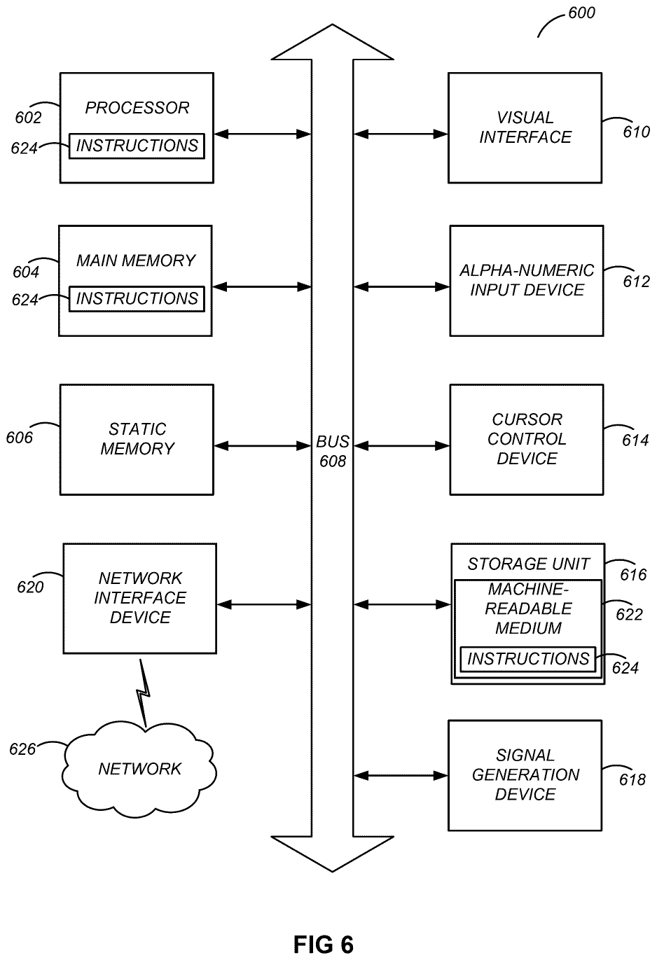

FIG. 6 is a block diagram illustrating components of an example machine able to read instructions from a machine-readable medium and execute them in a processor (or controller). FIG. (Figure) 6 is a block diagram illustrating components of an example machine able to read instructions from a machine-readable medium and execute them in a processor (or controller). Specifically, FIG. 6 shows a diagrammatic representation of a machine in the example form of a computer system 600 within which program code (e.g., software) for causing the machine to perform any one or more of the methodologies discussed herein may be executed. The program code may be comprised of instructions 624 executable by one or more processors 602. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processors 602 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 604, and a static memory 606, which are configured to communicate with each other via a bus 608. The computer system 600 may further include visual display interface 610. The visual interface may include a software driver that enables (or provide) user interfaces to render on a screen either directly or indirectly. The visual interface 610 may interface with a touch enabled screen. The computer system 600 may also include input devices 612 (e.g., a keyboard a mouse), a cursor control device 614, a storage unit 616, a signal generation device 618 (e.g., a microphone and/or speaker), and a network interface device 620, which also are configured to communicate via the bus 608.

The storage unit 616 includes a machine-readable medium 622 (e.g., magnetic disk or solid-state memory) on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution.

### Example Method for Vehicle Identification

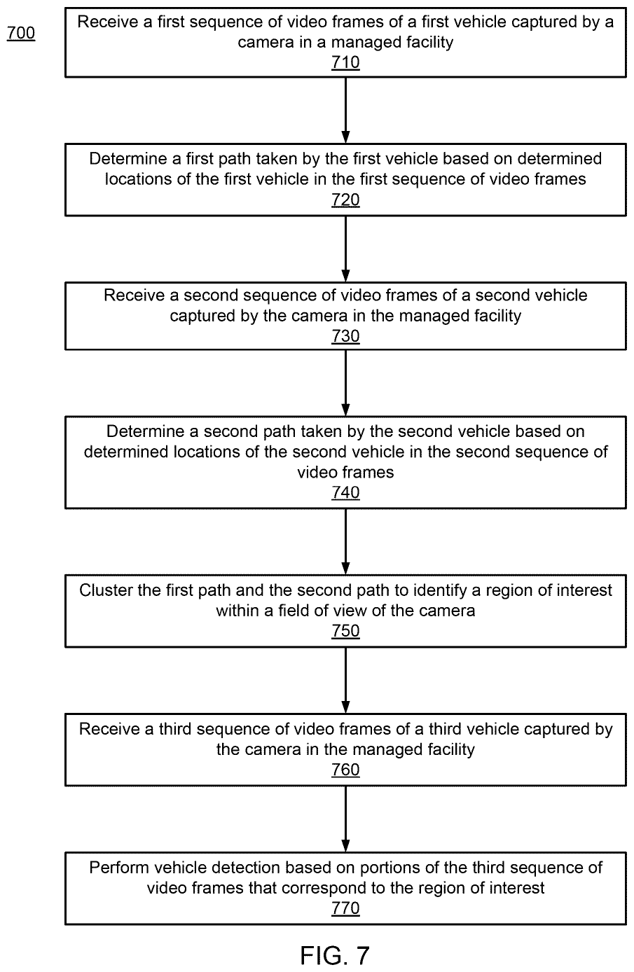

FIG. 7 is a flowchart of an example method for vehicle identification in a managed facility, in accordance with one or more embodiments. Alternative embodiments may include more, fewer, or different steps from those illustrated in FIG. 7, and the steps may be performed in a different order from that illustrated in FIG. 7. Method 700 may be executed by one or more processors of a system, which may include an edge device 110, a vehicle management server 130, and/or a client device 140. The one or more processors may include processor 602 of edge device 110 and/or of vehicle management server 130 executing instructions (e.g., instructions 624) that cause one or more modules to perform their respective operations.

The system receives 710 a first sequence of video frames of a first vehicle captured by a camera in a managed facility. The system determines 720 a first path taken by the first vehicle based on determined locations of the first vehicle in the first sequence of video frames. Similarly, the system receives 730 a second sequence of video frames of a second vehicle captured by the camera in the managed facility. The system determines 740 a second path taken by the second vehicle based on determined locations of the second vehicle in the second sequence of video frames.

In some embodiments, step 720 or 740 includes analyzing each video frame in the first sequence or the second sequence to detect and locate the first vehicle or the second vehicle within the video frame. The system may generate a bounding box to mark the location of the detected vehicle. The center of the vehicle can be determined as the center of the bounding box. By connecting the center points of the first vehicle or the second vehicle across the frames in the first sequence or the second sequence, the system can identify the first path or the second path traversed by the respective vehicle.

In some embodiments. identifying and locating the vehicle may include applying a vehicle detection model to the video frame to identify and locate the first vehicle or the second vehicle. In some embodiments, the vehicle detection model is trained by accessing a training dataset including images labeled with one or more vehicles (which are deemed as ground truth). The vehicle detection model is applied to the images within the training dataset to predict locations of vehicles, and backpropagation is performed to adjust parameters of the vehicle detection model to reduce differences between the predicted locations of vehicles and labeled locations of vehicles. In some embodiments, analyzing each video frame in the first or second sequence includes generating a bounding box marking a location of the first or second vehicle in the corresponding video frame.

In some embodiments, when a vehicle is detected, the vehicle detection model 412 places a bounding box around the detected vehicle in the image or video frame. The bounding box serves as a spatial marker that identifies the vehicle's location. The bounding box may correspond to coordinates such as center (x_center, y_center) or the top-left (x_top_left, y_top_left) position of the box, width and height of the bounding box. For example, if a vehicle is identified, a bounding box (x_center=320, y_center=240, width=100, height=50) is generated to specify a region in the image where the vehicle is located, allowing for further analysis or tracking. For example, (x_center=320, y_center=240) represents a pixel located 320 pixels from the left edge of the image and 240 pixels from the top edge of the image.

In some embodiments, the model also assigns a class label to each detected vehicle, such as car, truck, motorcycle. The bounding box is associated with a class label, indicating the type of the detected vehicle. In some embodiments, each detection is also associated with a confidence score, which indicates the model's certainty that the detected vehicle is indeed of the predicted class. For example, a confidence score of 0.9 for a car label indicates the model is 90% confident that the detected object is a car. In some embodiments, a threshold is set, and the system filters out low-confidence detections to reduce false positives.

The locations of the detected first vehicle and second vehicle are tracked to identify the first path and the second path. The system clusters 750 the first path and the second path to identify a region of interest within a field of view of the camera. In some embodiments, clustering the first path and the second path includes determining a distance between the first path and the second path. In response to determining that the distance between the first path and the second path is within a predetermined threshold, the system merges the first path and the second path into a single path that encompasses both the first path and the second path.

In some embodiments, clustering the first path and the second path includes identifying a first sequence of points along the first path, identifying a second sequence of points along the second path, and clustering the first sequence of points and the second sequence of points into one or more clusters based on their proximity to each other. In some embodiments, the points correspond to a center point of the vehicle in different image frames.

In some embodiments, the system clusters a first point in the first path and a second point in the second path into a first cluster. The system clusters a third point in the first path and a fourth point in the second path into a second cluster. In response to determining that a distance between the first cluster and the second cluster is within a predetermined threshold, the system merges the first cluster and the second cluster into a single cluster. In some embodiments, a boundary of the region of interest is determined based on spread of the clustered points. Alternatively, the boundary of the region of interest is further determined based on the width of a vehicle, which may correspond to the width of the first vehicle, the width of the second vehicle, the maximum width of any vehicle, or a typical vehicle width (e.g., an average or median width of vehicles).

In some embodiments, the system iteratively clusters points in the first path and points in the second path into clusters, and iteratively merges adjacent clusters to form at least one target region of interest. The system identifies a region of interest within the target region of interest that has a density of point greater than a predetermined threshold.

In some embodiments, the system further receives additional sequences of video frames capturing other vehicles within the managed facility. Each video frame in these additional sequences is analyzed to determine the location of each additional vehicle in the facility. Based on these determined locations, an additional path taken by each vehicle is identified. The region of interest is then adjusted according to the newly identified paths.

In some embodiments, the system further applies a machine learning model on pixels of a captured image (with or without a vehicle) to classify each pixel as part of a lane or not. The system segments areas in the captured image as a lane region or a non-lane region, and identifies the region of interest further based on the segmented lane region or non-lane region. The system determines the ROI further based on the segmented lane region or non-lane region.

In response to identifying the ROI, the system can perform targeted vehicle identification based on the identified ROI. For example, the system receives 760 a third sequence of video frames of a third vehicle captured by the camera in the managed facility. The system performs 770 vehicle detection based on portions of the third sequence of video frames that correspond to the region of interest. In some embodiments, the system generates a mask based on the identified region of interest, where the mask blocks areas outside this region. The system applies the mask to the third sequence of image frames, so that only the portions of video frames not blocked by the mask are processed for vehicle identification.

Further, lanes and driver behavior can change due to various reasons, such as construction, roadwork, temporary events, wear and tear of markings. Additionally, in areas like parking lots or large intersections without clear lane demarcations, drivers may improvise paths rather than strictly adhering to assume lanes. The embodiments described herein provide dynamic region of interest (ROI) detection that dynamically identify ROIs based on vehicle paths, allowing the system to respond to real-time or near real time traffic patterns.

In some embodiments, the system incorporates advanced 3D methodologies to enhance region of interest (ROI) identification while retaining compatibility with 2D camera inputs. For instance, a mixed 2D and 3D approach allows the system to generate 3D bounding boxes from 2D images using specialized object detection models. These 3D bounding boxes provide additional spatial information, such as object depth and orientation, which are leveraged to define more precise ROIs. Subsequent processing, such as lane segmentation and clustering, occurs in the 2D space to maintain computational efficiency. By integrating the boundaries of 3D bounding boxes into the 2D computations, the system achieves higher fidelity in ROI definition compared to traditional 2D-only methods.

In some embodiments, another 3D approach may also be implemented, wherein the system reconstructs a full 3D environment from 2D camera inputs using a 3D reconstruction model. In this configuration, all detection and tracking operations, including vehicle trajectory analysis and lane identification, are performed within the reconstructed 3D space. This approach enables the system to directly analyze spatial relationships and object orientations in a three-dimensional context. Once the ROIs are determined in the 3D space, they may be projected back into the 2D image space to optimize computational resource usage during subsequent processing steps.

These approaches expand the system's capabilities beyond traditional 2D workflows. For example, the mixed 2D and 3D approach leverages the strengths of both domains, combining computationally efficient 2D operations with the enhanced accuracy provided by 3D spatial insights. The pure 3D approach, while computationally intensive, offers unmatched precision for complex environments where depth and spatial relationships are critical. Both methods eliminate the need for LiDAR inputs, making them cost-effective solutions for environments where only 2D camera systems are available.

By integrating these 3D methodologies, the system significantly enhances the accuracy and adaptability of ROI determination in diverse scenarios. Whether through hybrid 2D-3D workflows or fully 3D operations, the system can dynamically refine ROIs based on enhanced object detection, lane segmentation, and vehicle tracking processes, ensuring optimal performance in real-time and resource-constrained environments.

### Example Managed Facility

FIGS. 8A-C depict embodiments of an exemplary managed facility and moveable gate. As depicted in FIG. 8A, a managed facility 800 includes a set of parking spaces 802 within which vehicles 805 (e.g., cars) may park. Managed facility 800 includes sensors, such as parking sensors 815 and cameras 112. Parking sensors 815 may be located within parking spaces 802 to detect when vehicles 805 are present. As depicted on the left-hand side of managed facility 800, managed facility 800 includes gates 114. The bottom gate 114 allows vehicles 805 to enter managed facility 800 from street 820 through an entry lane 840 and the top gate 114 allows vehicles 805 to exit managed facility 800 through an exit lane 835.

Managed facility 800 may include a pedestrian door 810, allowing pedestrians to enter from, for example, a sidewalk 830. The pedestrian door may be locked and RFID enabled such that users may enter through the pedestrian door responsive to edge device 110 receiving, from the user, a set of user credentials. Example user credentials may include user personal information, contact information, account information, and vehicle information (e.g., make, model, color, license plate).

FIG. 8A also depicts an infracting vehicle 806. Edge device 110 may, through infraction detection module 222, determine that vehicle 806 is an infracting vehicle due to the way vehicle 806 is parked, where the vehicle is talking up two parking spots 802 instead of one parking spot 802. Responsive to detecting the infraction, edge device 110 may trigger a remediation action that allocates for the use of the multiple parking spaces. Responsive to detecting some infractions, edge device 110 may trigger remediation actions that deploy an exit blocking device (e.g., gate 114) that prevents movement of vehicle 805 (or 806) out from managed facility 800.

FIGS. 8B and 8C depict embodiments of managed facility 800 in which a two-gate system is implemented in entry lane 840. The two-gate system includes a first gate 113 with cameras 112 pointed towards it and a second gate 115. Between the first gate 113 and the second gate 115 is a secondary zone 845. The secondary zone 845 includes access to the exit lane 835 (e.g., via crossing the dashed line). FIG. 8B shows operation of the two-gate system responsive to a non-infracting vehicle (e.g., vehicle 805) attempting to enter the managed facility. In FIG. 8B, responsive to detecting vehicle 805 at the first gate 113, edge device 110 may open the first gate 113, allowing vehicle 805 to pass into a secondary zone 845. While in the secondary zone 845, cameras 112 may take images of vehicle 805. Responsive to determining (e.g., through entry detection module 212) that vehicle 805 is not an infracting vehicle, edge device 110 may open the second gate 115, allowing vehicle 805 to enter managed facility 800. FIG. 8C shows operation of the two-gate system responsive to an infracting vehicle (e.g., vehicle 806) attempting to enter the managed facility. In FIG. 8C, responsive to detecting infracting vehicle 806 at the first gate 113, edge device 110 may open the first gate 113, allowing infracting vehicle 806 to pass into a secondary zone 845. While in the secondary zone 845, cameras 112 may take images of infracting vehicle 806. Responsive to determining (e.g., through entry detection module 212) that vehicle 806 is an infracting vehicle, instead of opening the second gate 115 as edge device 110 did for vehicle 805, edge device 110 may trigger a remediation action. For example, as a remediation action, edge device 110 may provide, for display at the second gate 115, a message to a user of infracting vehicle 806 asking the user to route infracting vehicle 806 into exit lane 835.

The aforementioned managed facility could be a parking facility that tags both entry and exit events for vehicles. However, different types of managed facilities might record a single tagged event or multiple tagged events per vehicle. For instance, a carwash facility might only tag a vehicle's entry into the wash area. Conversely, a drive-through restaurant could tag multiple events: one when a driver of the vehicle stops at a location for placing an order and another when the ordered items are handed over to the vehicle, completing the transaction. Additionally, an automated toll might tag just an entry or both an entry and exit event. In facilities that track multiple tagged events, vehicle misidentifications might be identified through unresolved (“hanging”) events. In contrast, facilities that record a single tagged event might detect misidentifications by comparing features between captured images of vehicles and registered vehicles within the system. Responsive to determining a misidentification of a vehicle, corrections can be made either manually or automatically, in a manner similar to that described above. For single tagged event scenarios, the correction data may be obtained without reference to another event. This correction data can also be used to generate additional training examples for retraining the machine-learning model for vehicle identification, continuously enhancing the accuracy of the machine-learning model through human-in-the-loop driven or automated retraining.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for seamless entry and exit to a managed facility blocked by a moveable gate through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for vehicle identification in a vehicle management system, comprising:
receiving a first sequence of video frames of a first vehicle captured by a camera in a managed facility;
determining a first path traversed by the first vehicle based on determined locations of the first vehicle in the first sequence of video frames;
receiving a second sequence of video frames of a second vehicle captured by the camera in the managed facility;
determining a second path traversed by the second vehicle based on determined locations of the second vehicle in the second sequence of video frames;
clustering the first path and the second path to identify a region of interest within a field of view of the camera;
responsive to receiving a third sequence of video frames of a third vehicle captured by the camera in the managed facility, performing vehicle identification based on portions of the third sequence of video frames that correspond to the region of interest.

2. The method of claim 1, the method further comprising:
applying a machine learning model on pixels of a captured image to classify each pixel as part of a lane or not;
segmenting areas in the captured image as a lane region or a non-lane region based on the classified pixels; and
adjusting the region of interest based on the segmented lane region or non-lane region.

3. The method of claim 2, wherein the adjusted region of interest is an intersection of the region of interest identified based on vehicle paths and the segmented lane region.

4. The method of claim 2, wherein the adjusted region of interest is a combination of the region of interest identified based on vehicle paths and the segmented lane region.

5. The method of claim 1, determining a first path traversed by the first vehicle or the second path traversed by the second vehicle comprising:
for each video frame in the first sequence or the second sequence of video frames,
applying a vehicle detection model to each video frame to identify and locate the first vehicle or the second vehicle;
generating a bounding box marking a location of the first vehicle or the second vehicle; and
identifying a center point of the bounding box;
connecting the center points of the first vehicle or the second vehicle in the first sequence or the second sequence of video frames to identify the first path or the second path traversed by the respective first vehicle or second vehicle.

6. The method of claim 5, wherein the vehicle detection model is trained by:
accessing a training dataset including images labeled with one or more vehicles;
applying the vehicle detection model to the images within the training dataset to predict locations of vehicles;
determining differences between the predicted locations of vehicles and labeled locations of vehicles; and
performing backpropagation to adjust parameters of the vehicle detection model to reduce differences between the predicted locations of vehicles and labeled locations of vehicles.

7. The method of claim 5, wherein clustering the first path and the second path comprises:
iteratively clustering center points of the first vehicle in the first path and center points of the second vehicle in the second path into clusters;
iteratively merging adjacent clusters, wherein the merged clusters form at least one target region of interest; and
identifying a region of interest within the target region of interest that has a density of point greater than a predetermined threshold.

8. The method of claim 7, wherein a boundary of the region of interest is determined based on spread of the clustered points.

9. The method of claim 1, wherein clustering the first path and the second path comprises:
determining a distance between the first path and the second path; and
responsive to determining that the distance between the first path and the second path is within a predetermined threshold, merging the first path and the second path into a single path that encompasses both the first path and the second path.

10. The method of claim 1, further comprising:
receiving an additional sequence of video frames of an additional vehicle captured by the camera in the managed facility;
determining an additional path traversed by the additional vehicle based on determined locations of the additional vehicle in the additional sequence of video frames; and
adjusting the region of interest further based on the determined additional path.

11. The method of claim 1, further comprising:
generating a mask based on the identified region of interest, wherein the mask covers areas outside the region of interest;
applying the mask to the third sequence of video frames; and
performing vehicle identification based on the masked third sequence of video frames.

12. A non-transitory computer-readable medium comprising memory with instructions encoded thereon, the instructions comprising instructions to cause one or more processors to perform steps comprising:
receiving a first sequence of video frames of a first vehicle captured by a camera in a managed facility;
determining a first path traversed by the first vehicle based on determined locations of the first vehicle in the first sequence of video frames;
receiving a second sequence of video frames of a second vehicle captured by the camera in the managed facility;
determining a second path traversed by the second vehicle based on determined locations of the second vehicle in the second sequence of video frames;
clustering the first path and the second path to identify a region of interest within a field of view of the camera;
responsive to receiving a third sequence of video frames of a third vehicle captured by the camera in the managed facility, performing vehicle identification based on portions of the third sequence of video frames that correspond to the region of interest.

13. The non-transitory computer-readable medium of claim 12, the steps further comprising:
applying a machine learning model on pixels of a captured image to classify each pixel as part of a lane or not;
segmenting areas in the captured image as a lane region or a non-lane region based on the classified pixels; and
adjusting the region of interest based on the segmented lane region or non-lane region.

14. The non-transitory computer-readable medium of claim 13, wherein the adjusted region of interest is an intersection of the region of interest identified based on vehicle paths and the segmented lane region.

15. The non-transitory computer-readable medium of claim 13, wherein the adjusted region of interest is a combination of the region of interest identified based on vehicle paths and the segmented lane region.

16. The non-transitory computer-readable medium of claim 12, determining a first path traversed by the first vehicle or the second path traversed by the second vehicle comprising:
for each video frame in the first sequence or the second sequence of video frames,
applying a vehicle detection model to each video frame to identify and locate the first vehicle or the second vehicle;
generating a bounding box marking a location of the first vehicle or the second vehicle; and
identifying a center point of the bounding box;
connecting the center points in the first sequence or the second sequence of video frames to identify the first path or the second path traversed by the respective first vehicle or second vehicle.

17. The non-transitory computer-readable medium of claim 16, wherein the vehicle detection model is trained by:
accessing a training dataset including images labeled with one or more vehicles;
applying the vehicle detection model to the images within the training dataset to predict locations of vehicles;
determining differences between the predicted locations of vehicles and labeled locations of vehicles; and
performing backpropagation to adjust parameters of the vehicle detection model to reduce differences between the predicted locations of vehicles and labeled locations of vehicle.

18. The non-transitory computer-readable medium of claim 16, wherein clustering the first path and the second path comprises:
iteratively clustering center points of the first vehicle in the first path and center points of the second vehicle in the second path into clusters;
iteratively merging adjacent clusters, wherein the merged clusters form at least one target region of interest; and
identifying a region of interest within the target region of interest that has a density of point greater than a predetermined threshold.

19. The non-transitory computer-readable medium of claim 18, wherein a boundary of the region of interest is determined based on spread of the clustered points.

20. A system comprising:
memory with instructions encoded thereon; and
one or more processors that, when executing the instructions, are caused to perform operations comprising:
receiving a first sequence of video frames of a first vehicle captured by a camera in a managed facility;
determining a first path traversed by the first vehicle based on determined locations of the first vehicle in the first sequence of video frames;
receiving a second sequence of video frames of a second vehicle captured by the camera in the managed facility;
determining a second path traversed by the second vehicle based on determined locations of the second vehicle in the second sequence of video frames;
clustering the first path and the second path to identify a region of interest within a field of view of the camera;
responsive to receiving a third sequence of video frames of a third vehicle captured by the camera in the managed facility, performing vehicle identification based on portions of the third sequence of video frames that correspond to the region of interest.
